(19) United States
(12) Patent Application Publication
(10) Pub. No.: US 2012/0003346 A1
(43) Pub. Date: Jan. 5, 2012

(54) SHEET SURFACE TREATING APPARATUS

(75) Inventors: Yasunori Chigono, Atsugi-shi (JP); Makoto Fukatsu, Suntou-gun (JP); Emi Hagiwara, Yokohama-shi (JP); Shintaro Ishida, Toda-shi (JP); Shunichi Takada, Yokohama-shi (JP)

(73) Assignee: CANON KABUSHIKI KAISHA, Tokyo (JP)

(21) Appl. No.: 13/173,755

(22) Filed: Jun. 30, 2011

(30) Foreign Application Priority Data
Jun. 30, 2010 (JP) 2010-149183(PAT.)
Jun. 30, 2010 (JP) 2010-149185(PAT.)
Jun. 30, 2010 (JP) 2010-149186(PAT.)

(51) Int. Cl. B29C 59/04; B28B 3/12

(52) U.S. Cl. 425/363

(57) ABSTRACT

A sheet surface treating apparatus includes a heater including a substrate and a heat generating element provided on the substrate; a transfer film which is movable while contacting the heater; a pressing member cooperating with the heater to form a nip for feeding a sheet carrying thermoplastic resin material, through the transfer film; wherein the sheet is fed by the nip together with the transfer film in a state that the thermoplastic resin material is in contact with the transfer film, and is heated by the heater in the nip so that a configuration of a surface of the transfer film is transferred to the thermoplastic resin material, and then is separated from the transfer film; wherein a downstream end of the heat generating element with respect to a sheet feeding direction is disposed at a position upstream of an end of the nip with respect to the sheet feeding direction, and a distance between the downstream end of the nip and the downstream end of the heat generating element is not less than 0.4 mm and not more than 2.5 mm.

### FIELD OF THE INVENTION AND RELATED ART

The present invention relates to a surface treating device for a sheet carrying thermoplastic resin material such a toner image, for example.

Conventionally, in most of prints, the glossiness of a recording material is different from that of the coloring material, and therefore, the glossiness is different by a print ratio. In order to provide a uniform overall glossiness of a print, various proposals have been made as to post-processes (surface treatment) by over-coating or the like using a heating apparatus. Furthermore, recently, various proposals have been made to control the glossiness.

For example, in an offset printing, the printing is effected by coloring ink, and then an offset printing is effected to a particular portions using transparent ink having an UV curing property, and thereafter, the entirety is fixed by overall UV projection. By this, the glossiness of the particular portions is raised to produce a print having rich visual effect. In Japanese Laid-open Patent Application 2007-086747, photograph-like recording is proposed wherein the glossiness of an entirety of the print is raised. Japanese Laid-open Patent Application Hei 10-315515, and Japanese Laid-open Patent Application 2000-301749 propose an overall glossiness treatment in a heat recording system. Japanese Laid-open Patent Application 2004-170548 and Japanese Laid-open Patent Application Hei 07-068808 propose a means for partial glossiness treatment.

However, in the conventional glossiness treatment methods, it is difficult to effect partial photograph-like glossiness treatment. Here, the photograph-like means a high glossiness not less than 40%, further particularly, not less than 80% in 60 degrees glossiness. Although the various means for imparting a high glossiness have been proposed as mentioned above, no partial treatment method has not been found. Here, the partial glossiness treatment means the glossiness treatment for any given area or shape depending on characters of heading and/or the content of the print, including a treatment for upper half photograph region. The glossiness treatment is not limited to increase of the glossiness and includes decrease of the glossiness to a desired degree. It includes the treatment for a surface of satin texture.

Japanese Laid-open Patent Application 2004-170548 discloses a partial photograph-like treatment, wherein however, a particular shape, such as a top half of the sheet, has to be prepared on a belt beforehand, and therefore, it is not really treatment of a given area. In Japanese Laid-open Patent Application 2004-170548, it is disclosed that the glossiness of the heated station is raised by a thermal head, a sufficient glossiness treatment would not been provided only by the heating using the thermal head. In the glossiness treatment, the part to be treated is melted, close-contacted, cooled and then peeled, and only then the glossiness treatment is completed. In an example using a thermal head as disclosed in Japanese Laid-open Patent Application 2004-170548, the order of steps and the temperature control therefor are not disclosed, and therefore, the partial high glossiness treatment is not expected.

In Japanese Laid-open Patent Application Hei 10-31551, the ink layer melted and transferred is reheated using a thermal head and ink film having a resin material layer, by which the ink layer is re-fused, and then the ink film is peeled off after the re-fused ink layer is cooled and solidified. However, no method is disclosed about the improvement of the glossiness locally. As for the cooling and solidification, only disclosure is that the ink film is peeled off after spontaneous cooling and solidification, no positive cooling is intended.

Japanese Laid-open Patent Application 2000-301749 discloses that the glossiness enhancement effect can be provided by the re-heating. Particularly, it discloses that the glossiness treatment is possible by keeping a desired temperature range by pre-heating of the thermal head or by contacting to a heat radiation member. Again, in Japanese Laid-open Patent Application 2000-301749, no method is disclosed as to a partial enhancement of the glossiness, similarly to Japanese Laid-open Patent Application Hei 10-31551. In Japanese Laid-open Patent Application 2000-301749, all of the elements of the thermal head is heated, and the electric power to the thermal head is adjusted such that the back side temperature of the thermal head is within a desired range. With such a structure, it is difficult to keep the back side temperature constant for partial heating and non-heating, because of a print ratio or a distribution thereof. In addition, the operation time is additionally required, with the result of the decrease in the processing power.

Japanese Laid-open Patent Application Hei 07-068808 discloses partial enhancement of the glossiness using a thermal head, but is silent about the cooling step after the heating. In addition, nothing is disclosed about a problem with partial head temperature rise resulting from repeated operations.

As a result of the inventors' investigations for partial glossiness treatment, a problem peculiar to the partial heating is found.

In a part of the glossiness treating area, the surface property of the film cannot be correctly transferred, in the case of high glossiness film, for example, a low glossiness partly results in some cases. Particularly, this glossiness defect appears at an edge portion of the glossiness treating area, and is considered as being peculiar to the partial heating or separation.

### SUMMARY OF THE INVENTION

Accordingly, it is a principal object of the present invention to provide a heating apparatus which is capable of selective surface treating wherein the surface treatment state in the edge of the surface treatment area.

According to an aspect of the present invention, there is provided a sheet surface treating apparatus comprising a heater including a substrate and a heat generating element provided on said substrate; a transfer film which is movable while contacting said heater; a pressing member cooperating with said heater to form a nip for feeding a sheet carrying thermoplastic resin material, through said transfer film; wherein the sheet is fed by the nip together with said transfer film in a state that the thermoplastic resin material is in contact with said transfer film, and is heated by said heater in the nip so that a configuration of a surface of said transfer film is transferred to the thermoplastic resin material, and then is separated from said transfer film; wherein a downstream end of the said heat generating element with respect to a sheet feeding direction is disposed at a position upstream of an end of the said nip with respect to the sheet feeding direction, and a distance between the downstream end of the said nip and the downstream end of the said heat generating element is not less than 0.4 mm and not more than 2.5 mm.

These and other objects, features, and advantages of the present invention will become more apparent upon consideration of the following description of the preferred embodiments of the present invention, taken in conjunction with the accompanying drawings.

### BRIEF DESCRIPTION OF THE DRAWINGS

FIG. 1 is a sectional view illustrating a substantial structure of a glossiness processing device according to a first embodiment.

FIG. 2 illustrates a substantial structure of a driving circuit of a thermal head.

FIG. 3 is a schematic view illustrating a structure of a heat generating element of the thermal head.

FIG. 4 is a schematic sectional view illustrating a structure of a major part of glossiness processing device.

FIG. 5 is a schematic sectional view illustrating a structure of a major part of glossiness processing device.

FIG. 6 is a schematic sectional view illustrating a structure of a major part of glossiness processing device.

FIG. 7 is a schematic sectional view illustrating a structure of a major part of a glossiness processing device of a comparison example 1.

FIG. 8 shows an example of an output having a glossiness defect at an edge portion.

FIG. 9 is a sectional view illustrating a substantial structure of a glossiness processing device according to a second embodiment.

FIG. 10 is a schematic sectional view illustrating a structure of a major part of the glossiness processing device.

FIG. 11 is a schematic sectional view illustrating a structure of a major part of the glossiness processing device.

FIG. 12 is a schematic view of an apparatus for measuring a bonding strength.

FIG. 13 is a schematic view illustrating a decreased glossiness.

FIG. 14 is a schematic sectional view of a coarse image surface.

FIG. 15 is a schematic view wherein the recording material is not separated from the film and enters between rollers.

FIG. 16 shows an image figure illustrating deformation of toner on the sheet.

FIG. 17 is a model of deformation of the toner.

FIG. 18 illustrates a difference in the glossiness.

### DESCRIPTION OF THE PREFERRED EMBODIMENTS

Hereinafter, the preferred embodiments of the present invention are described in detail with reference to the appended drawings. Incidentally, the measurement, material, and shape of any of the structural components of the apparatuses and devices in the following embodiments of the present invention, are to be modified as necessary according to the structure of an apparatus and a device to which the present invention is applied, and the various conditions under which the apparatus and device are operated. In other words, the following embodiments of the present invention are not intended to limit the present invention in scope.

The following embodiments of the present invention are described with reference to an example of a heating apparatus in accordance with the present invention, more specifically, a gloss alteration apparatus, that is, an apparatus for altering any part or parts of a print (image) in gloss. The gloss alteration apparatus in any of the following embodiments of the present invention is such an apparatus that transfers the texture (one of surface properties) of its gloss alteration film onto a part or parts of a print (material to be treated) by heating the print (object to be heated) through the gloss alteration film with the use of a thermal head.

### First Embodiment

### General Structure of Apparatus

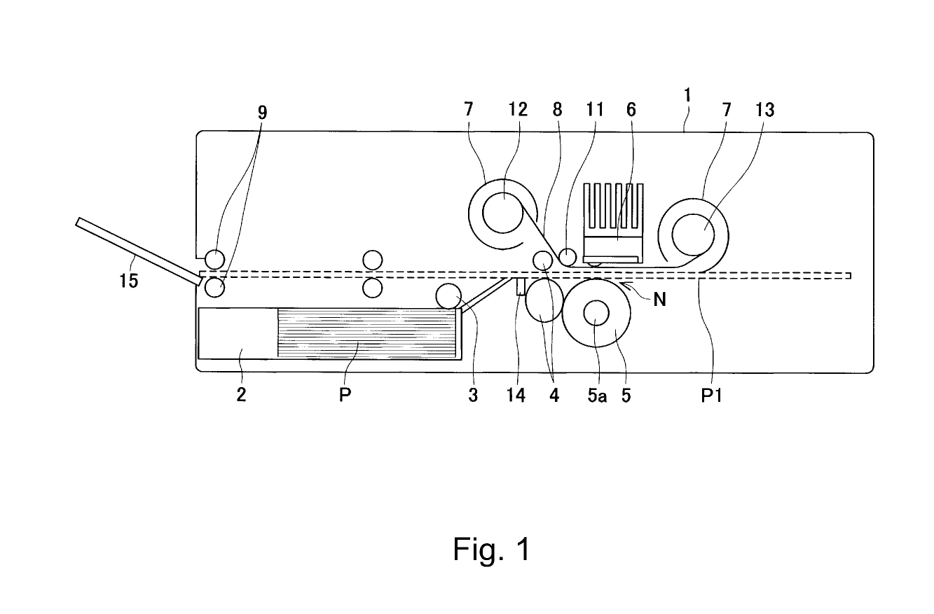

FIG. 1 is a schematic sectional view of the gloss alteration apparatus in the first preferred embodiment of the present invention, and shows the general structure of the apparatus. The gloss alteration apparatus in this embodiment alters a print in gloss by transferring the texture of its gloss alteration film onto the surface layer of the print, which is formed of thermoplastic resin. More specifically, it softens the thermoplastic layer of the print by heating, and then, alters the texture of the thermoplastic layer with the use of the texture of the gloss alteration film. First, the general structure of the gloss alteration apparatus is described.

Referring to FIG. 1, designated by referential numerals 1, 2, and 3 are: the main assembly of the apparatus; a cassette in which multiple sheets P (of recording medium) are stored; and a sheet feeder roller which feeds each of the sheets P in the cassette 2, into the apparatus main assembly 1 while separating it from the rest. Designated by a referential numeral 4 is a pair of sheet conveyance rollers which catch the sheet P conveyed thereto by the sheet feeder roller 3, and conveys the sheet P toward the sheet processing station (heating station: heating nip) while keeping the sheet P between the pair of rollers. The gloss alteration apparatus is structured so that the pair of sheet conveyance rollers 4 can convey the sheet P either forward or backward. Designated by a referential numeral 14 is a sensor which detects the leading edge of the sheet P when the sheet P is conveyed to the processing start position P. Designated by a referential numeral 5 is a platen roller as a pressure applying member, which is positioned on the opposite side of the sheet conveyance passage from a thermal head 6 which is such a heater that can be turned on or off according to the information regarding the intended surface treatment.

Designated by a referential numeral 8 is a gloss alteration film (which hereafter will be referred to simply as film 8), which is pressed on the sheet P and is heated by the thermal head 6 which can selectively heat numerous points of the film 8. Designated by a referential numeral 7 is a film cassette (film storage: film chamber) in which the film 8 is stored. Designated by referential numerals 12 and 13 are a film supply shaft and a film take-up shaft, respectively. Designated by a referential numeral 11 is a separating member which separates the film 8 from the sheet P after the film 8 is pressed, while heated, upon the sheet P by the thermal head 6. Designated by referential numerals 9 are pair of discharge rollers which discharge the sheet P out of the apparatus main assembly 1. Designated by a referential numeral 15 is a delivery tray.

### (Thermal Head)

Next, the thermal head 6 is described about its basic structure and specification. FIG. 3 is a schematic sectional view of the thermal head 6. It is for describing the structure of the heating member of the thermal head 6. The thermal head 6 comprises: a substrate 21; a glaze 22 (thermal insulation layer); a heat generating member 25; a common electrode 23a; and a lead electrodes 23b. The substrate 21 is formed of aluminum or the like. First, the glaze 22 is formed on the substrate 21 by printing. Then, the heat generating member 25 was formed on the substrate 25, and then, the common electrode 23a and lead electrode 23b were formed in a manner to cover the substrate 21 and parts of the heat generating member 25 (heat generating member 25 is in contact with the bottom surface of each of electrodes 23a and 23b). The thermal head 6 has also a protective film 24 (overcoat layer), which covers the substrate 21, thermal insulation reserve layer 22, electrodes 23a and 23b, and heat generating member 25. Further, the thermal head 6 has also: a driver circuit which selectively supplies heat generating members 25 with electric power to cause the heat generating members 25 to generate heat; and a heat radiation plate for radiating the excessive amount of heat, that is, the heat remaining after the heating of the sheet P; and the like structural members. The gloss alteration apparatus in this embodiment is provided with a controlling means for controlling the amount by which heat is generated by the heat generating member 25, with the use of the heater driving circuit.

The thermal head 6 in this embodiment was 300 dpi in the heat generating member density, 300 dpi in the recording density, 30 V in the driving voltage, and 5,000Ω in the average electrical resistance of the heat generating members 25. However, this embodiment is not intended to limit the present invention in terms of the structure and specification of the thermal head 6. That is, the present invention is also applicable to a thermal head (6) which is different in structure and specification from the one in this embodiment.

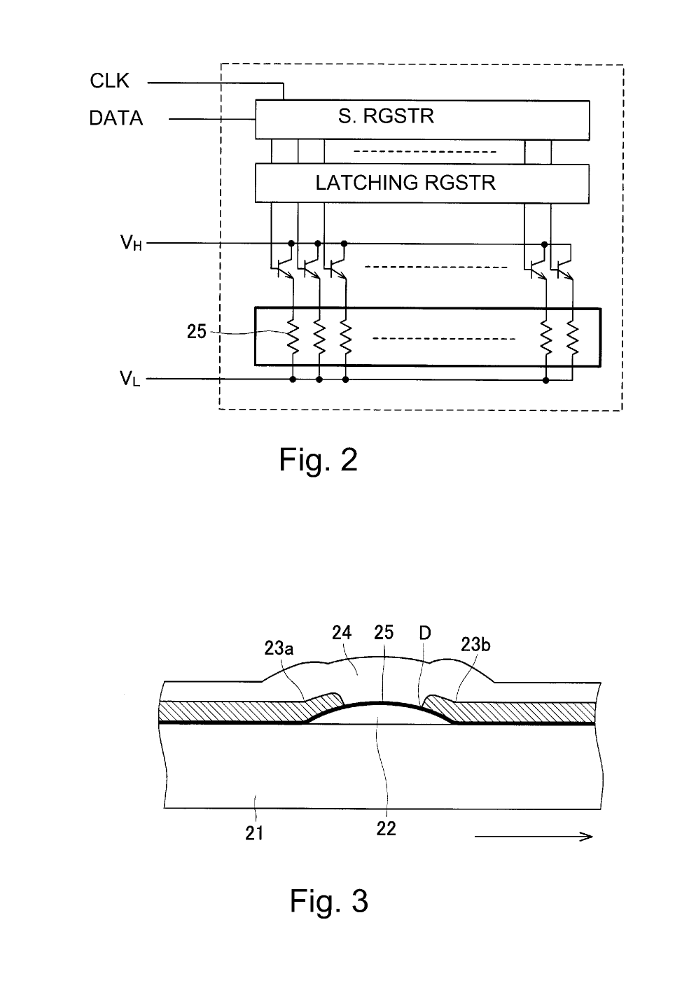

FIG. 2 is a schematic drawing of the circuit for driving the thermal head 6. It shows the general structure of the circuit.

The thermal head 6 has multiple heating lines, which are on the substrate 1. Each heating line is made up of multiple heating members 25 aligned in the direction in which the heating line extends. One of the aforementioned pair of electrodes 23a and 23b is on one side of the heating line, and the other is on the other side of the heating line. As for a driver IC which includes a group of resistors which retain and transfer the data for each heating line is on the same substrate (substrate on which heating lines are), or a wiring substrate, that is, a substrate other than the substrate 1.

The thermal head 6, structured as described above, is capable of controlling each of the multiple heat generating members 25 independently from the other heat generating members in terms of the amount by which each heat generating member generates heat. In other words, it is structured so that it can selectively heat any point of the sheet P. Thus, the gloss alteration apparatus in this embodiment can selectively alter any point of the surface of the sheet P in gloss. Since the thermal head 6 in this embodiment is structured so that as the sheet P is conveyed with the film 8 through the nip N, the thermal head 6 can heat a part, parts, or the entirety of the combination of the sheet P and film 8, in terms of the lengthwise direction of the thermal head 6. Therefore, the thermal head 6 can change any part or parts of the surface of the sheet P in gloss.

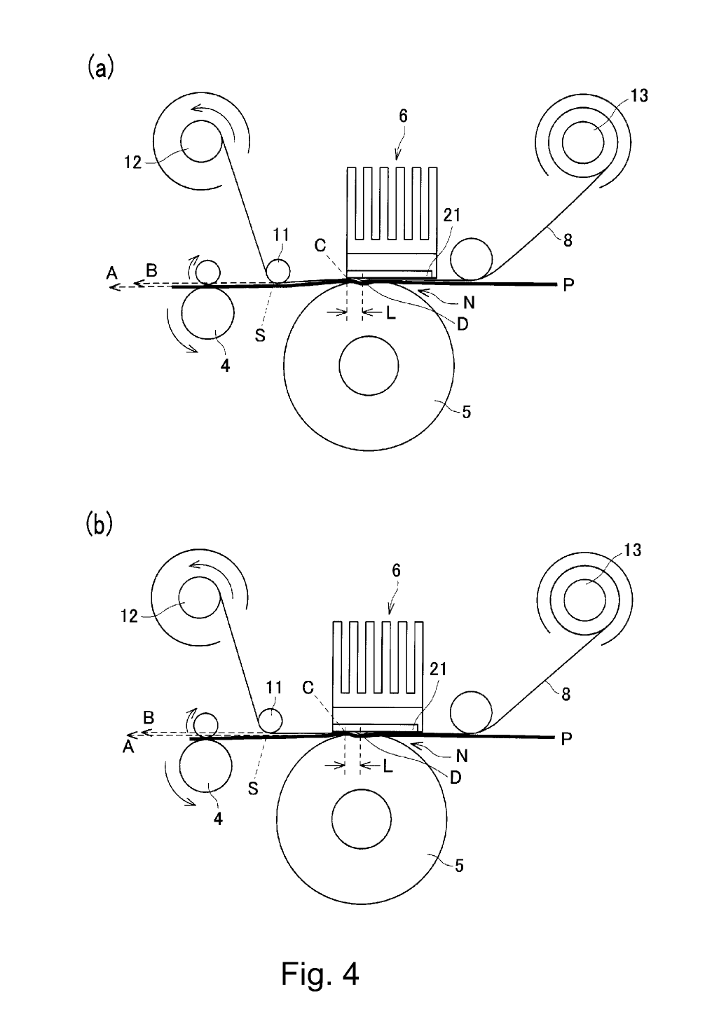

FIG. 4(a) is a schematic sectional view of the gloss alteration apparatus in this embodiment. It is for describing the structure of the essential portions of the apparatus.

What is essential for the gloss alteration apparatus in this embodiment to properly alter the surface of a sheet of recording medium in gloss is the structure of the adjacencies of each heat generating member 25. The nip N in this embodiment is the interface between the film 8 and platen roller 5. More specifically, it is the interface between the portion of the film 8, a part of which is in contact with the heat generating member 25, and the plate roller 5.

The inventors of the present invention paid attention to the distance L in FIG. 4(a). The distance L is the distance between the downstream edge D of each heat generating member 25 and the downstream edge C of the nip N in terms of the moving direction of the film 8. That is, the gloss alteration apparatus in this embodiment is structured so that in terms of the direction in which the film 8 is moved in the nip N, the downstream edge C of the nip N is downstream by the distance L from the downstream edge of the heating generating member 25. Referring to FIG. 3, the downstream edge D of the heat generating member 25 coincides in position with the point of contact between the upstream edge of the downstream electrode and the heat generating member 25 (arrow mark in FIG. 3 indicated direction in which film 8 and sheet P move). An arrow mark A indicates the direction in which the sheet P is moved (immediately after sheet P is moved past downstream edge C) at the downstream edge C of the nip N, whereas an arrow mark B indicates the direction in which the film 8 is moved at the downstream edge C of the nip N.

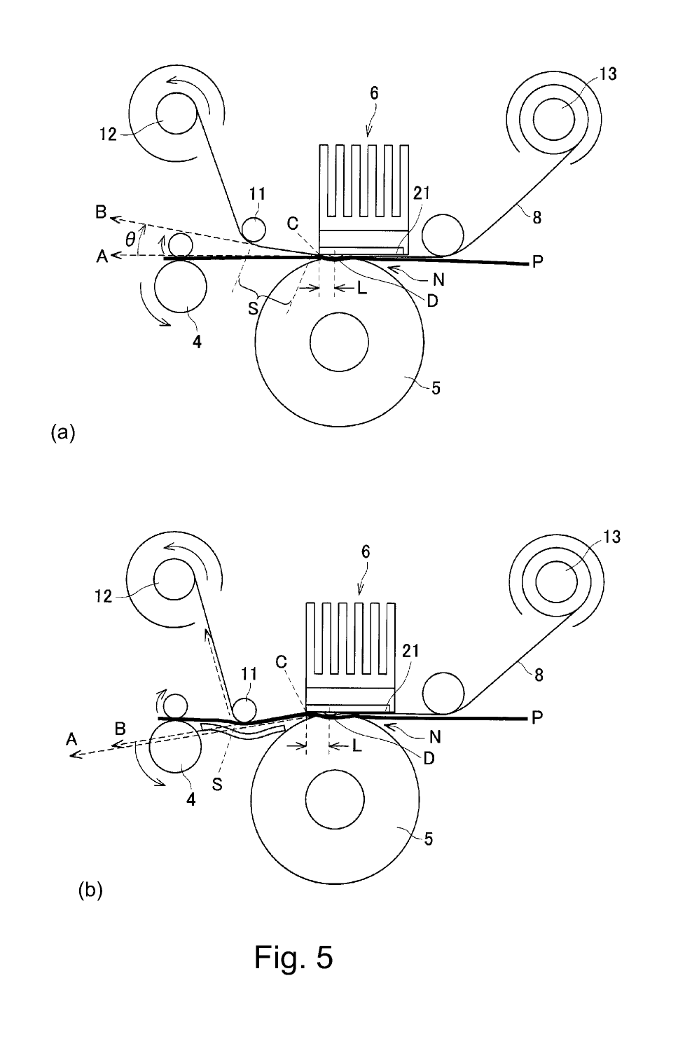

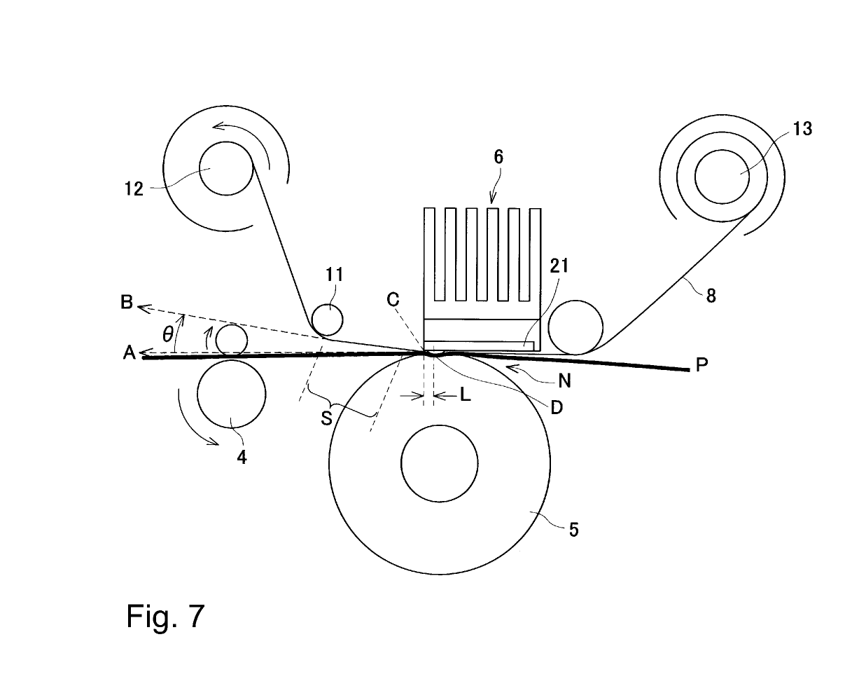

Referring to FIG. 4(a), the thermal head 6 is under the full pressure from the platen 5. Thus, the downstream edge C of the nip N coincides in position with the downstream edge of the substrate 21 of the thermal head 6, and therefore, the distance L may be defined as the distance from the downstream edge D of the heat generating member 25 and the downstream edge of the substrate 21. The letter S in FIG. 4(a) stands for the point at which the film 8 separates from the sheet P (in FIGS. 5(a) and 7, it stands for range in which film 8 separates from sheet P).

The gloss alteration apparatus, the general structure of which is shown in FIG. 4(b), is one of the modified versions of the gloss alteration apparatus in this embodiment, the general structure of which is shown in FIG. 4(a). The structure of the apparatus in FIG. 4(b) is different from the structure of the apparatus in this embodiment shown in FIG. 4(a), in the position of the platen roller 5 relative to the thermal head 6. The former is an example of the gloss alteration apparatus, the downstream edge of the nip N of which does not coincide in position with the downstream edge of its substrate 21. In this embodiment, the position of the downstream edge D of the heat generating member 25 can be determined from the position of the heat generating member 25 of the thermal head 6.

In this embodiment, the position of the downstream edge C of the nip N is defined as the position determined with the used of the following method:

The sheet P of recording medium (coated paper: Aurora coat (157 g/m²) and film 8 (film (2), specification of which will be given later) are placed between the thermal head 6 and platen roller 5 and are kept pinched by the head 6 and roller 5. Then, the position is determined from the pressure distribution in the nip, which is obtained by inserting a pressure measuring film (PRESCALE film) between the film 8 and sheet P while the film 8 and sheet P are kept pinched by the head 6 and roller 5. The pressure measuring film used in this embodiment is a pressure measuring film Prescale made by Fuji Film Co., Ltd., and is for measuring micro pressure. Prescale is of the two-sheet type. However, only the film A, which is coated with a coloring agent was inserted into the nip N with the coloring agent bearing surface facing the film 8. More concretely, first, the platen roller 5, sheet P, Prescale film A, film 8, and thermal head 6 were stacked in the listed order. Then, a preset amount of pressure was applied to the stack, and the stack was kept under the preset amount of pressure for 10 seconds. Thereafter, the pressure was removed. Then, Prescale film A was removed from the stack. Then, the surface of Prescale film A was studied with the use of a microscope, finding thereby the downstream edge of the area of Prescale film A, across which the micro-capsules as the coloring agents had deformed (changed in color). Then, the position of the downstream edge of the nip N, which corresponds in position to the downstream end of the area of Prescale film A, across which the micro-capsules had deformed (changed in color), was determined from the position of the downstream edge of the downstream edge of the area of Prescale film A, which had changed in color).

That is, the position of the downstream edge C of the nip N is determined from the positional relationship among the sheet P, Prescale film A, and the thermal head 6. Then, the value of the distance L was obtained based on the position of the downstream edge D of the heat generating member 25.

### (Platen Roller)

The platen roller 5 is prepared by forming, in a roller shape a member having a high friction coefficient, such as a hard rubber. For example, the platen roller 5 is a rubber roller using a silicone rubber or the like and is rotatably mounted in the apparatus main assembly 1 by a shaft 5a. The platen roller 5 is provided at an opposite side from the thermal head 6 via the film 8.

### (Film)

The film 8 is provided slidably on the thermal head 6 and has a surface shape for subjecting the sheet P including the thermoplastic resin material at its surface (at an image forming surface side). Further, the film 8 is constituted by a thin flexible material in order to locally heat the sheet surface. From this viewpoint, the film thickness may desirably be 40 μm or less. From the viewpoint of glossing (gloss treatment), the glossing can be performed until the film thickness of 2 μm but from the viewpoint of film strength, the film thickness may preferably be 4 μm or more. Further, in glossing, in order to obtain a surface property excellent in photograph-like image clarity, it is effective that the film 8 has rigidity to some extent. In the case of materials shown below, the film thickness may preferably be 8 μm or more. Further, with respect to the film material, the material is required to possess a heat resistance property against the thermal head 6. The material, such as polyimide, having the heat resistance property which exceeds 200 degrees is preferred. However, although a heating history remains, it is also possible to use a film of a general resin material such as PET (polyethylene terephthalate).

In this embodiment, as a specific transfer film, either of the following film members was used.

Film (1): PET film, thickness of 8 μm

Film (2): PET film+parting coating, thickness of 9 μm

In the film (2), a surface layer (surface to be contacted to the sheet P) is subjected to parting coating. This functional layer is a coating layer with low surface energy and the parting coating has been effected in order to improve a parting property between the film 8 and the thermoplastic resin material at the sheet P surface. In the case where the case where the surface shape of the film 8 is transferred, from the viewpoint such that how to accurately transfer the shape of the film 8 onto the sheet P, it is desirable that the film 8 and the sheet P are smoothly parted (separated) from each other. As a composition for this purpose, it is possible to use, e.g., a fluorine-containing resin material, a silicone resin material, and the like. Further, as a forming method, the coating is used in this embodiment but the forming method is not limited thereto. It is important that the film can possess the surface property (surface shape) to be transferred. In this embodiment, in order to create a smooth surface for photograph, the film is prepared by subjecting a base film to the coating. It is also possible to use, e.g., a polypropylene-based film for which the base film alone has the low surface energy. However, the polypropylene-based resin material has a low heat-resistant temperature and therefore specification degradation occurs unless sticking prevention at a back surface, a lowering in amount of overheating, low-speed recording and the like are devised. In this embodiment, from balance of these factors, the film as described above was used. Further, the surface layer has a contact angle with respect to water, of 90 degrees, thus possessing an excellent parting performance. The surface layer may preferably have the contact angle (with respect to water) of 80 degrees or more in order to keep the parting performance. The contact angle, with respect to water, of the surface layer of the film (1) was 75 degrees.

The back surface (slidable with the thermal head 6) of each of the films (1) and (2) is provided with a sticking prevention layer. This layer is provided in order to reduce mechanical friction with the thermal head 6. The sticking prevention layer is required to possess a property close to that of the parting coating described above and therefore specifically, coating with the fluorine-containing resin material or the silicone resin material similarly as in the case of the parting layer.

The film 8 in this embodiment, in order to transfer its surface shape, can be processed so as to have a high-gloss and photograph-like (glossy) surface when the film 8 is a high-gloss smooth film. Further, on the other hand, by using a matte film prepared by sandblast or a film provided with a particular shape, a reverse shape of the surface shape can be transferred onto the sheet P. It is possible to transfer shapes with various feels and textures such as those of matte (silky)-finish paper, Japanese Paper and embossed paper. Further, it is also possible to provide a geometric pattern, so that various feeds and textures such as a lattice pattern. Further, by forming a geometric structure on the order of 1 μm to submicrometers, it is possible to transfer a surface which assumes hologram color.

In this embodiment, the sheet P surface can be partly subjected to the glossing and therefore a plurality of the films as described above are provided, so that various shapes and hologram color can be provided at only necessary positions of the sheet P.

### (Separating Member)

The separating member 11 will be described below in detail. In this embodiment, constitutions of the thermal head 6 and the separating member 11 are very important.

The separating member 11 performs two functions consisting of a film cooling function and a film separating function based on curvature. The separating member 11 is, as shown in (A) of FIG. 4, constituted by metal such as SUS (stainless steel) and a separation curvature thereof is set at a sufficiently small value (1 mm in terms of a radius of curvature in this embodiment), so that the separating member 11 is constituted so that the gloss-treated sheet P and the film 8 can be parted with more reliability. Further, it is desirable that a cooling mechanism (not shown) for suppressing temperature rise of the separating member 11. In this regard, e.g., air cooling or mounting of a cooling fin is effective.

Further, by monitoring a temperature of the separating member 11 by using thermistors provided at a plurality of portions, a fan or a printing operation may be controlled so that the temperature of the separating member 11 is not more than a target cooling temperature T1 (° C.).

The target cooling temperature T1 may desirably be made equal to Tg (glass transition point) of the surface layer resin material, such as a colorant or an overcoating material, on the sheet P. When a deviation between Tg and melting start point is taken into consideration, the target cooling temperature T1 may preferably be set at about Tg+15 degrees, further preferably at Tg or less. Further, some colorant layer is formed of the surface layer materials containing a component such as wax in addition to the resin material and the colorant. In this case, the target cooling temperature T1 may preferably be set at a temperature which is not less than a melting point of the wax. For example, the temperature may preferably be about 30-50° C.

### (Sheet (Cut Paper))

In this embodiment, as the sheet (material to be treated), a recording material (print) outputted from the electrophotographic recording apparatus was used. As the recording material, art paper (coated paper) for printing (basis weight: 157 g/m²) was used. In this embodiment, two types of recording materials on which an image (recording image) was formed by a 4-color process using four color toners (thermoplastic resin materials) of CMYK (cyan, magenta, yellow, black) and a 5-color process using transparent toner, which is principally consisting of a thermoplastic resin material containing no colorant, in addition to the four color toners were used. The transparent toner was, after separation output into CMYK, supplied to a portion where a print ratio was low, so that a print pattern was determined so as to cover the entire recording material with the transparent toner and then was outputted. As a result, it becomes possible to perform the glossing at an arbitrary place of the recording material. Further, a fixing state of the toner in the electrophotographic recording apparatus was adjusted so that the glossiness of the recording material by the electrophotographic recording was about 10% in terms of 60 degree-glossiness.

Further, in this embodiment, with respect to the sheet, the glossing is not limited to those in the above-described 4-color and 5-color processes but can similarly be performed also in the case where the image is formed, by the 4-color process, on the sheet which is subjected to a coating with the thermoplastic resin material. Further, also with respect to the sheets on which recording is effected by thermofusible transfer recording, sublimation (dye) thermal transfer recording, ink jet recording or the like, the glossing is similarly performed. Also in these cases, it becomes possible to perform the glossing at an arbitrary place of the entire surface of the sheet by covering the sheet surface with a thermoplastic material such as the thermoplastic resin material or the max. Further, also with respect to the recording image by the thermofusible transfer recording, i.e., the image with image information recorded on the sheet by the wax layer (of the thermoplastic material) containing the colorant, the glossing can be similarly performed.

Thus, in this embodiment, the sheet on which the thermoplastic material is carried includes the case where the material for forming the image on the sheet is the thermoplastic material and the case where the thermoplastic material is coated on the image-formed surface.

### [Operation}

In the apparatus main assembly 1 shown in FIG. 1, when the sheet P on which the image is recorded is fed one by one from the cassette 2 by the feeding roller 3, the sheet P is nip-conveyed toward the nip N by the sheet feeding roller pair 4. At this time, pressure applied to the nip N is released. When the sheet P is conveyed toward the nip N, a time when a leading end of the sheet P passes through the sensor 14 for detecting the leading end of the sheet P is counted, so that a length of the sheet P is measured.

The processing portion, i.e., the nip N is formed between the film 8 and the platen roller 5 by oppositely disposing the platen roller 5 and the thermal head 6 via the sheet conveying path and the film 8. The sheet feeding is completed when a trailing end of the fed sheet reaches the feeding roller pair 4. Thereafter, the pressure is applied to the nip N, so that the feeding roller pair 4 starts its rotation in an opposite direction to that during the sheet feeding. In a state in which the film 8 is located on the sheet P (a state in which the sheet P and the film 8 are superposed), the sheet P and the film 8 are moved in the nip N while being heated and pressed. Here, in the state in which the film 8 is located on the sheet P, the image-formed surface of the sheet P is in a state in which it is contacted to the film 8.

Further, during the pressing in the nip N of the film 8 and the sheet P moving together with the film 8, each of the heat generating elements of the thermal head 6 is heated on the basis of gloss information for the glossing. Thereafter, the film 8 and the sheet P are separated by the separating member 11, so that desired glossing is effected. The gloss-treated sheet P is then discharged on the tray 15.

The thermal head 6 performs the glossing on the sheet P nip-conveyed with the film 8 and is constituted so as to urge the platen roller 5 via the film 8. Specifically, the platen roller 5 is mounted rotatably about the shaft 5a in the apparatus main assembly 1. When the sensor 14 detects that the sheet P is conveyed to a glossing start position, the platen roller 5 is urged against the thermal head 6.

Therefore, when the platen roller 5 is rotated in a state in which the film 8 is inserted between the platen roller 5 and the thermal head 6, the film feeding shaft 13 and the film winding shaft 12 which are not provided with the driving source are rotated by the rotation of the platen roller 5, so that the film 8 is conveyed by a desired length. The film 8 is wound by a length corresponding to the length of the sheet P and after the end of the glossing, the platen roller 5 is spaced from the thermal head 6. The sheet P nip-conveyed in the nip N is guided to the discharging roller pair 9 and is discharged to the outside of the casing, so that the glossing is ended. Incidentally, as the sheet P, rolled paper is also usable.

In this embodiment, a constitution in which the glossing can be performed plural times while reciprocating the sheet P by the sheet feeding roller pair 4 is employed but the present invention is not limited to such a constitution. For example, it is also possible to effect the glossing while rotating a platen drum plural times. Further, it is also possible to employ a constitution in which the platen roller is directly driven and the glossing is effected only one time with respect to one direction.

Further, a constitution in which the thermal head 6 is movably constituted and the glossing is effected by moving the thermal head 6 in a predetermined range in the nip N may be employed.

That is, the constitution in which the glossing is effected by moving the sheet P and the film 8, which are in the superposed state (contact state), relative to the thermal head 6 may be employed.

Further, a movement (conveyance) speed of the sheet P during the glossing in this embodiment was controlled at 50 mm/s.

Further, in this embodiment, depending on a signal level of the glossing (recording image), a pulse width or the number of an energization pulse supplied to the heat generating elements 25 is finely controlled. The recording is effected in a manner such that when one-line treatment based on line print every one line as a unit is ended, the sheet feeding roller pair 4 is rotated by an angle corresponding to one line and the sheet P is moved, so that the film 8 follows the sheet P and is moved in the same distance.

### (Energization System)

An energization system is classified into a system in which the number of pulses is made constant and an energization pulse width is controlled and a system in which a constant pulse width train is prepared and the number at pulses is controlled. The former can design a careful gradation-density characteristic but on the other hand, a halftone control portion is complicated. In the latter, the constant pulse width train is prepared and an input gradation level is only allocated again. Therefore, a load on the halftone control portion is light but in order to realize a careful density characteristic, there is a need to prepare the number of pulses which is considerably larger than the number of actual gradation levels.

### [Evaluation Methods]

### (Glossiness (at 60 Degrees and 20 Degrees))

Evaluation of glossiness was performed by measuring 60 degree-glossiness and 20 degree-glossiness of the image. The glossiness was measured by a gloss meter (“TRI-gloss meter”, mfd. by BYK Gardner Inc.). An image sample used for measurement was prepared by outputting, on an A4-sized recording material, patches of 10 colors in total including transparent of the transparent toner in addition to 9 colors consisting of an untreated portion color, CMYK colors, secondary color and tertiary color and then by recording an about 1 inch-square gloss data image on the recording material. This sample image was subjected to measurement of the glossiness by the gloss meter.

In this embodiment, in order to evaluate the photograph-like high-gloss surface, evaluation was made according to the following criterion.

o: 80% or more of 60 degree-glossiness

x: Less than 80% of 60 degree-glossiness

### (Improper Gloss at Edge Portion))

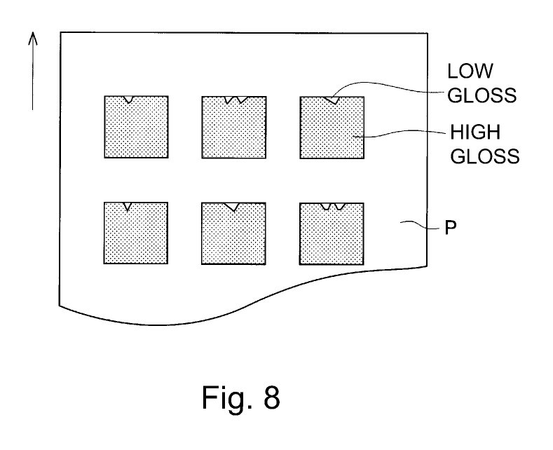

A solid black (Bk) image is printed over the whole surface of the A4-sized sheet (recording material) P. Thereafter, by the glossing device, ½-inch-square solid Bk pitches are processed with gloss data at ⅓-inch intervals so as to cover the A4-sized sheet area. An output example is shown in FIG. 8. In FIG. 8, a high gloss portion is indicated by a dotted region. The problematic improper gloss at en edge portion appears at a low gloss portion shown in FIG. 8 and is characterized in that it occurs at the edge of a trailing end portion of associated patches. A proportion of the occurrence of this image defect patches to the whole patches is obtained. The improper gloss was evaluated according to the following five levels in combination with the following subjective impressions.

1: Improper gloss is observed at 90% or more of the patches.

2: Clear improper gloss is observed at 50% to less than 90% of the patches.

3. Clear improper gloss is observed at 30% to less than 50% of the patches.

4: Slight improper gloss is observed at more than 10% to 20% of the patches.

5: Slight improper gloss is observed at 10% or less of the patches.

Hereinbelow, Comparative Embodiments and Embodiments will be described. Incidentally, the glossing devices in the respective embodiment basically have the same constitution as that of the above-described glossing device and therefore, for the sake of explanation, constituent portions or members similar to those in the above-described glossing device are represented by the same reference numerals or symbols.

### [Comparative Gloss Alteration Apparatus 1]

FIG. 7 is a schematic sectional view of the first comparative gloss alteration apparatus. It shows the general structure of the essential portions of the apparatus.

This comparative gloss alteration apparatus is an example of a gloss alteration apparatus, the film of which does not have a parting layer on its sheet facing surface. Next, the unique feature of this apparatus in terms of the positioning of the essential components is described. As described above, the inventors of the present invention paid attention to the distance L, that is, the distance between the downstream edge D of the heat generating member 25 and the downstream edge C of the nip N. This comparative apparatus was structured so that the distance L became 0.2 mm, which is very short. Generally, in the case of a thermalgloss alteration apparatus, in order to ensure that heat is efficiently transmitted from the heat source of the gloss alteration apparatus to its gloss alteration film, and also, that coloring agents are uniformly adhered to recording medium to yield a print (copy) which is uniform (normal) in appearance, the apparatus is devised so that the contact pressure between the heat source, and an object to be heated (recording medium) is high.

Therefore, it is a common practice to place a glaze under each of the heat generating members of a thermal head, and/or to structure a gloss alteration apparatus so that each heat generating member is positioned at the edge of the substrate of a thermal head, by which the thermal head is placed in contact with the platen. The inventors of the present invention paid attention to also the angle between the sheet conveyance direction A and the film movement direction B at the downstream edge C of the nip N (this angle hereafter may be referred to as angle θ). The amount of this angle θ is affected by the position of the separating member 11. In the case of this comparative gloss alteration apparatus, the value of the angle θ is roughly 11 degrees, and the film 8 is taken up (rolled up) as if it were pulled upward in FIG. 7.

### [Comparative Gloss Alteration Apparatus 2]

Unlike the first comparative gloss alteration apparatus, the second comparative gloss alteration apparatus employs a film, which has a parting layer on its sheet facing surface. In order for a gloss alteration apparatus to yield a copy (print), the image bearing surface of which is as glossy as a photograph, the gloss alteration apparatus has to excel in terms of the separation of its gloss alteration film from the sheet P.

### Embodiment 1

FIG. 5(a) is a schematic sectional view of the gloss alteration apparatus in the first preferred embodiment of the present invention. It shows the structure of the essential portions of the apparatus. Not only are the essential components of the gloss alteration apparatus in this embodiment positioned as shown in FIG. 5(a), but also, it employs a film having a parting layer, and is positioned so that the parting layer faces the sheet P. Further, the apparatus is structured so that the distance L, or the distance between the downstream edge D of the heat generating member 25 and the downstream edge C of the nip N is 0.4 mm, and also, so that the angle θ, or the angle between the film 8 and sheet P at the downstream edge C of the nip N is 11 degrees.

### Embodiment 2

In the case of the gloss alteration apparatus in this embodiment, its essential components are positioned as shown in FIG. 4(a). More concretely, the distance L is 0.4 mm, and the angle θ is roughly zero. In other words, the separating member 11 is positioned so that at the downstream edge C of the nip N, the moving direction A of the sheet P is roughly the same as the moving direction B of the film 8. Positioning the separating member 11 as described above makes the film 8 separate from the surface-treated sheet P, on the downstream side of the downstream edge C of the nip N, in terms of the moving direction of the sheet P relative to the thermal head 6 (separating member 11 is positioned so that movement of sheet P relative to thermal head 6 between downstream edge C and separating member 11 is same as that of film 8). Further, the film 8 has a parting layer.

### Embodiment 3

In this embodiment, the essential components of the gloss alteration apparatus are positioned as shown in FIG. 4(a). More concretely, the distance L is 0.7 mm, and the angle θ is roughly zero. The film 8 has a parting layer.

### Embodiment 4

In this embodiment, the essential components of the gloss alteration apparatus are positioned as shown in FIG. 4(a). More concretely, the distance L is 1.0 mm, and the angle θ is roughly zero. The film 8 has a parting layer.

### Embodiment 5

In this embodiment, the essential components of the gloss alteration apparatus are positioned as shown in FIG. 5(a). More concretely, the distance L is 1.0 mm, and the angle θ is roughly 11 degree. The film 8 has a parting layer.

### Embodiment 6

In this embodiment, the essential components of the gloss alteration apparatus are positioned as shown in FIG. 4(a). More concretely, the distance L is 2.0 mm, and the angle θ is roughly zero. The film 8 has a parting layer.

### Embodiment 7

FIG. 5(b) is a schematic sectional view of the gloss alteration apparatus in the seventh embodiment. It shows the structure of the essential components of the gloss alteration apparatus. The gloss alteration apparatus in this embodiment is different in structure from the gloss alteration apparatus in any of the preceding embodiments in that the separating member 11 in this embodiment is different in position from the separating member 11 in any of the preceding embodiments. The sheet P is conveyed along the line which connects the interface of the pair of sheet conveyance rollers 4 and the nip N of the thermal head 6. FIG. 4(a) represents the gloss alteration apparatus, the separating member 11 of which is positioned so that the bottommost point of the peripheral surface of the separating member 11 roughly aligns with the sheet P conveyance passage. In this embodiment, the separating member 11 is positioned so that the bottommost point of the peripheral surface of the separating member 11 is below the recording medium (sheet P) conveyance passage as shown in FIG. 5(b). Positioning the separating member 11 as shown in FIG. 5(b) ensures the angle between the moving direction of the film 8 and that of the sheet P becomes zero. The distance L is 0.7 mm, and the film 8 has a parting layer.

### Embodiment 8

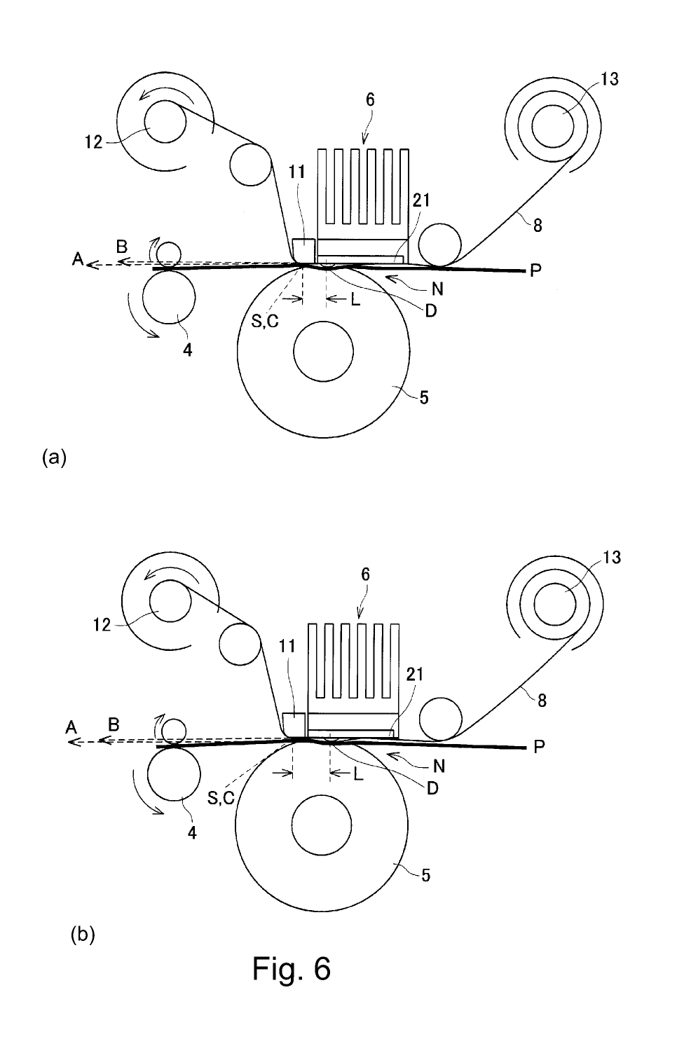

FIG. 6(a) is a schematic sectional view of the gloss alteration apparatus in the eighth embodiment of the present invention. It shows the structure of the essential portion of the apparatus. The thermal head 6 in this embodiment is the same as the thermal head shown in FIG. 7. However, the separating member 11 in this embodiment is different in shape and positioning from that in the seventh embodiment. That is, referring to FIG. 6(a), the separating member 11 in this embodiment is positioned right next to the downstream edge of the substrate 21 of the thermal head 6. Further, the gloss alteration apparatus is structured so that the separating member 11 is in contact with the portion of the film 8, which is in the area in which the film 8 forms the nip N against the platen roller 5. Further, the separating member 11 in this embodiment separates the sheet P from the transfer film immediately after the sheet P is processed. In this embodiment, therefore, the nip N is the combination of the nip which the separating member 11 forms against the platen roller 5, and the nip which the thermal head 6 forms against the platen roller 5. Thus, the position of the downstream edge C of the nip N coincides with the position of the downstream edge of the separating member 11. That is, the gloss alteration apparatus in this embodiment is structured, as described above, so that the distance L becomes 2.0 mm, and also, so that the film 8 is separated from the sheet P immediately after the film 8 and sheet P are heated by the thermal head 6. The angle θ is roughly zero, and the film 8 is provided with a parting layer.

### Embodiment 9

FIG. 6(b) is a schematic sectional view of the gloss alteration apparatus in the ninth preferred embodiment of the present invention. It shows the structure of the essential portions of the apparatus.

The gloss alteration apparatus in this embodiment is structured so that its separating member 11 is the same in shape and positioning as that shown in FIG. 6(a). Also in this embodiment, the distance L is 2.5 mm, which is the largest among all the preferred embodiments of the present invention, and the angle θ is roughly zero. Further, the film 8 has a parting layer.

### Embodiment 10

The essential components of the gloss alteration apparatus in this embodiment are positioned as shown in FIG. 4(b). More concretely, the distance L is 1.0 mm, and the angle θ is roughly zero. The film 8 has a parting layer.

### [Results of Evaluation of Gloss Alteration Apparatuses in Preferred Embodiments and Comparative Gloss Alteration Apparatuses]

Table 1 shows the evaluation of the gloss alteration apparatuses in the preceding preferred embodiments of the present invention, and comparative gloss alteration apparatuses, and also, the unique structural features of the gloss alteration apparatuses.

TABLE 1

| | Film | | | | | | |
|---|---|---|---|---|---|---|---|
| | | Surface material | Cooling Separation | | | Evaluation | |
| | | (PC = parting | Length | | Continuous | | Edge defect |
| | No. | Coat) | (mm) | Angle θ (deg) | pressure | 60-Glossines | of glossines |
| Emb. 1 | 1 | PET + PC | 0.4 | 11 | No | ◯ | 3 |
| Emb. 2 | 2 | PET + PC | 0.4 | Nearly do. | No | ◯ | 3 |
| Emb. 3 | 2 | PET + PC | 0.4 | Nearly do. | No | ◯ | 4 |
| Emb. 4 | 2 | PET + PC | 1 | Nearly do. | No | ◯ | 4 |
| Emb. 5 | 1 | PET + PC | 1 | 11 | No | ◯ | 4 |
| Emb. 6 | 2 | PET + PC | 2 | Nearly do. | No | ◯ | 4 |
| Emb. 7 | 3 | PET + PC | 0.7 | 0 | No | ◯ | 4 |
| Emb. 8 | 4 | PET + PC | 2 | Nearly do. | Yes | ◯ | 5 |
| Emb. 9 | 5 | PET + PC | 2.5 | Nearly do. | Yes | ◯ | 5 |
| Emb. 10 | 6 | PET + PC | 1 | Nearly do. | Yes | ◯ | 4 |
| Comp. 1 | 7 | PET | 0.2 | 11 | No | x | — |
| Comp. 2 | 7 | PET + PC | 0.2 | 11 | No | ◯ | 1 |

In the case of the first comparative gloss alteration apparatus, its film 8 was formed of PET, and therefore, had a very flat and smooth surface. But, it was difficult for the gloss alteration apparatus to provide the sheet P with a flat and smooth surface, that is, a glossy surface, which is evident from the 60 degrees gloss value of the resultant prints. More concretely, the sheet P which was altered in gloss by the first comparative gloss alteration apparatus was 60% in 60 degree gloss, which was below the gloss of the surface of PET film. As for the gloss of the edge portions of the test patch, it was too low to deserve evaluation.

The second comparative gloss alteration apparatus is an example of a gloss alteration apparatus, the film 8 of which is provided with a parting layer which faces the sheet P, in order to deal with the problem which the first comparative gloss alteration apparatus has, that is, the problem that a print outputted by the first comparative gloss alteration apparatus was too low in gloss. In the case of the second comparative gloss alteration apparatus, the gloss was as high as 85% in 60 degrees gloss, because the film 8 was provided with the parting layer. In other words, the second comparative gloss alteration apparatus outputted a print as glossy as a photographic image. However, the second comparative gloss alteration apparatus suffered from a problem which is different from the problem the first comparative gloss alteration apparatus suffered. That is, when the second comparative gloss alteration apparatus structured as described above was used to change a specific area or areas of the sheet P in gloss, some prints suffered from the problem that the gloss of a part or parts of the edge portions of the gloss altered area were lower than the intended level as shown in FIG. 8. Thus, the inventors of the present invention have concern that when it is only the photographic portions of a print that is to be altered in gloss with the use of the second comparative gloss alteration apparatus, the gloss alteration apparatus might output a print (gloss-altered print) which suffers from the problem that a part or parts of some of the photographic portions of the print are wrong in gloss level, and therefore, is very low in image quality.

Therefore, in the case of the preceding embodiments, the inventors of the present invention improved a gloss alteration apparatus by paying attention to the distance L. The distance L is the distance between the downstream edge D of the heat generating member 25 and the downstream edge C of the nip N, as described above. It will be evident from the description of the preferred embodiments 2, 3, 4, and 6 that structuring a gloss alteration apparatus so that the distance L becomes no less than 0.4 mm drastically improves the gloss alteration apparatus in terms of the improper gloss. More specifically, it is desired that a gloss alteration apparatus is structured so that the distance L is no less than 1.0 mm and no more than 2.5 mm.

In the case of a conventional image forming apparatus which thermally records images, the level of quality at which the apparatus outputs images is closely related to how high the contact pressure between its heating member and a sheet of recording medium. Therefore, the thermal head has been variously devised. For example, the thermal head was provided with the glaze, and its heat generating member was placed on the glaze, or the heat generating member was positioned at the edge of the substrate, and the thermal head was pressed against the platen by tiling the substrate. However, in a case where an image heating apparatus is used as a gloss alteration apparatus, what is important is the state of film 8 and the state of a print (sheet of recording medium and image thereon) after the heating. Obviously, it is possible to separate the film 8 from the sheet after they naturally cool down. However, this solution cannot eliminate the problem that when a part or parts of a print are to be altered in gloss, the edge portions of the parts do not correctly come out in terms of gloss.

The relationship between the distance L and the gloss error can be expected to be as follows:

The film 8 has to be placed perfectly in contact with the sheet P, and has to be kept perfectly in contact with the sheet P until they both cool down. However, the film 8 shrinks as it is subjected to heat. Thus, it is possible that if the pressure which has been keeping a given portion of the film 8 perfectly in contact with the sheet P is removed immediately after the portion of the film 8 has passed by the heat generating member 25, the film 8 will be peeled away from the sheet P by the stress stored in the film 8 by the thermal shrinkage of the film 8. That is, if the film 8 and sheet P are not sufficiently cooled down by the time when the film 8 is peeled away from the sheet P, the film 8 will be peeled away from the sheet P when they are high in temperature, and therefore, it is possible that the surface texture of the film 8 will not be accurately transferred onto the sheet P, and therefore, the gloss alteration apparatus will output a print which suffers the problem that the downstream portions of the gloss altered portions of the print are wrong in gloss. Incidentally, the inventors of the present invention assumed that the gloss error of this type was unlikely to occur to the upstream edge portion of the areas of a print, which is to be altered in gloss, because if the film 8 remains perfectly in contact with the sheet P across the upstream edge portion when the film 8 and sheet P are freed from the nip pressure, the film 8 is unlikely to separate from the sheet P.

In this embodiment, therefore, in order to prevent a given portion of the film 8 from shrinking as it is conveyed out of the nip N after being heated in the nip N by the heat generating member 25, the distance L is set so that the portion of the film 8 is in the nip N even after being heated by the heat generating member 25. That is, the gloss alteration apparatus is structured so that in terms of the moving direction of the sheet P relative to the thermal head 6, the downstream edge D of the heat generating member 25 is on the upstream side of the downstream edge C of the nip N. Structuring a gloss alteration apparatus so that the distance L becomes no less than 0.4 mm, in particular, no less than 1.0 mm, drastically improve the gloss alteration apparatus in image quality in terms of gloss. In other words, there is a very strong relationship between the distance L and the problem that a gloss alteration apparatus yield prints (images) which are unsatisfactory in gloss.

The tenth embodiment, which is the same in terms of the length of the distance L as the fourth embodiment, tended to be slightly better in image quality in terms of gloss than the fourth embodiment. It seems to be reasonable to assume that conveying the film 8 and sheet P along the surface of the substrate 21 of the thermal head 6 as in the tenth embodiment prevents the premature peeling (separation) of the film 8 from the sheet P, which is one of the causes of yielding of prints (images) which are unsatisfactory in image quality in terms of gloss. Further, structuring a gloss alteration apparatus so that both the separating member 11 and pair of sheet conveyance rollers 4 are positioned higher than their position in FIG. 4(a) to ensure that the film 8 and sheet P follow the heating surface of the thermal head 6 is also effective. Incidentally, none of the gloss alteration apparatuses in the preferred embodiments of the present invention was structured in this manner.

Next, the effect of the angle θ upon the improvement of a gloss alteration apparatus in image quality in terms of gloss is described based on the comparison among the first, second, fourth, and fifth preferred embodiments of the present invention. In a case where the distance L is short, changing a gloss alteration apparatus in the angle θ seems to reduce the gloss alteration apparatus in terms of gloss error, although this cannot be detected in the ranking of the apparatuses in Table 1. Further, the angle θ affects a gloss alteration apparatus in another aspect of gloss error. More concretely, in a case where the angle θ is 11 degrees, which is relatively small, as in the first and fifth embodiments, the area S in which the film 8 separates from the sheet P remains unstable in position. That is, the force which works in the direction to cause the film 8 to separate from the sheet P is very small compared to the force which works in the direction to pull the film 8 (direction in which the film 8 is to be moved). This force which works in the direction to cause the film 8 to separate from the sheet P is a component of the force which works in the direction to pull the film 8, at the generatrix of the platen roller 5, and is very small. Therefore, the point at which the film 8 separates from the sheet P is inconsistent in position in terms of the recording medium conveyance direction, which sometimes causes the gloss alteration apparatus to output a print which is unsatisfactory in gloss in that it appears as if the print is made up of multiple long strips which are different in gloss level. In consideration of the above described problems, a gloss alteration apparatus is desired to be structured so that the angle θ becomes virtually zero, and also, that in terms of the moving direction of the sheet P relative to the thermal head 6, the separating member 11 which causes the film 8 to separate from the sheet P after the surface treatment of the sheet P is on the downstream side of the downstream edge C of the nip N.

Further, in the seventh embodiment, the gloss alteration apparatus was structured to ensure that the angle θ became zero. Therefore, it was ensured that the film 8 separates from the sheet P within a range S. Therefore, the film 8 reliably separated from the sheet P.

Further, the comparison between the sixth and eighth embodiments shows that the eighth embodiment is superior to the sixth embodiment in image quality in terms of gloss. Therefore, it is evident that structuring a gloss alteration apparatus so that the film 8 is separated from the sheet P immediately after the passage of the sheet P through the nip N is even better. In a case where the gloss alteration apparatus is structured as in the eighth embodiment, it is required that the separating member 11 remains fully cooled, and the film 8 and sheet P will have been fully cooled before the film 8 will be separated from the sheet P. Thus, it is desired that a gloss alteration apparatus is provided with a system for cooling the separating member 11 as described previously. However, in a case where only a part or parts of the sheet P are heated by the heat generating members 25, the film 8 and sheet P will be satisfactorily cooled by the separating member 11, because the separating member 11 can function also as a cooling member.

As described above, according to the preceding preferred embodiments of the present invention, it is possible for a gloss alteration apparatus to heat any area or areas of the sheet P in the heating pattern of its thermal head 6, including to heat the sheet P to yield a print which is as glossy as a photograph. Further, it is possible to drastically improve a gloss alteration apparatus in terms of the nonuniformity in gloss which occurs to the sheet P, in particular, across the edge portion of the part or parts of the print to be altered in gloss, when a part or parts of the sheet P are altered in gloss by the gloss alteration apparatus to yield a print, which are highly glossy only across a part or parts of the print.

Further, structuring a gloss alteration apparatus so that the angle θ becomes roughly zero improves the gloss alteration apparatus in terms of the gloss irregularity (i.e., lower gloss than intended) of the edge portion of each of the areas of the print to be altered in gloss, as well as the gloss irregularity in the form of multiple strips different in gloss.

Further, structuring a gloss alteration apparatus so that the nip N is formed by the combination of the substrate 2 and separating member 11 can further improve the apparatus in terms of the gloss irregularity (i.e., lower gloss than intended) which occur to the edge portion of an area or areas of the sheet P, which are to be altered in gloss.

Incidentally, in this embodiment, the thermal head 6 is provided with the plurality of heat generating elements and can effect partial glossing at the surface of the sheet P but the direction is not limited thereto. It is also possible to employ a constitution in which a single heat generating element is provided on the substrate along a sheet width direction (axial direction of the platen roller 5) perpendicular to the movement direction of the sheet P.

Further, in this embodiment, the glossing device is described as the surface treating device but the present invention is not limited thereto. The surface treating device of the present invention may be any device capable of effecting surface treatment such that the thermoplastic resin material on the sheet P is softened by heating and then is deformed by using the surface shape of the film and thus the surface shape of the film is transferred onto the thermoplastic resin material. For example, it is possible to use a device for effecting the surface treatment by which the surface of the thermoplastic resin material is formed in a plurality of small pyramidal shapes.

Next, Second Embodiment of the present invention will be described. Second Embodiment is different, in constitution of the separating portion between the transfer film and the sheet, from First Embodiment described above. In Second Embodiment, at the separating portion, the separation of the coating layer of the transfer film is suppressed.

### Second Embodiment

### General Structure of Glossing Device

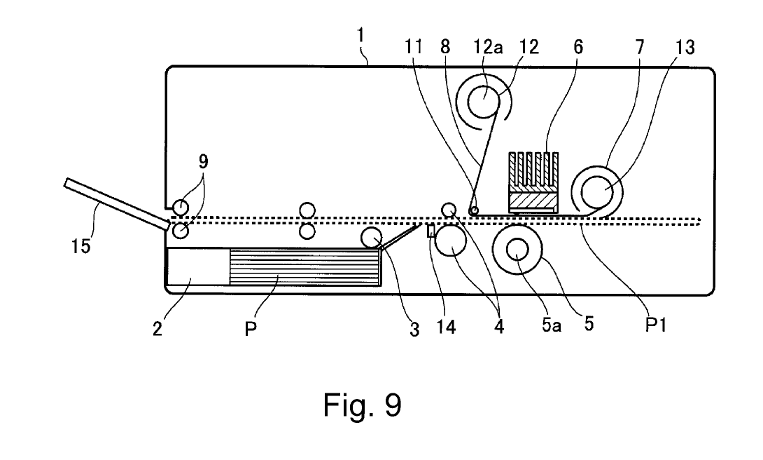

FIG. 9 is a schematic sectional view of the glossing device in this embodiment. A difference from First Embodiment (FIG. 1) is the constitution of the separating portion and other portions are the same as those in First Embodiment. The difference from First Embodiment will be principally described below.

### (Film)

The film 8 is provided slidably on the thermal head 6 and has a surface shape for subjecting the sheet P including the thermoplastic resin material at its surface (at an image forming surface side). Further, the film 8 is constituted by a thin flexible material in order to locally heat the sheet surface. From this viewpoint, the film thickness may desirably be 40 μm or less. From the viewpoint of glossing (gloss treatment), the glossing can be performed until the film thickness of 2 μm but from the viewpoint of film strength, the film thickness may preferably be 4 μm or more. Further, in glossing, in order to obtain a surface property excellent in photograph-like image clarity, it is effective that the film 8 has rigidity to some extent. In the case of materials shown below, the film thickness may preferably be 8 μm or more. Further, with respect to the film material, the material is required to possess a heat resistance property against the thermal head 6. The material, such as polyimide, having the heat resistance property which exceeds 200 degrees is preferred. However, although a heating history remains, it is also possible to use a film of a general resin material such as PET (polyethylene terephthalate).

In this embodiment, as a specific transfer film, an 8 μm-thick film including PET film and parting coating. The film surface layer (surface to be contacted to the sheet P) is subjected to parting coating. This functional layer is a coating layer with low surface energy and the parting coating has been effected in order to improve a parting property between the film 8 and the thermoplastic resin material at the sheet P surface. In the case where the case where the surface shape of the film 8 is transferred, from the viewpoint such that how to accurately transfer the shape of the film 8 onto the sheet P, it is desirable that the film 8 and the sheet P are smoothly parted (separated) from each other. As a composition for this purpose, it is possible to use, e.g., a fluorine-containing resin material, a silicone resin material, and the like. In this embodiment, in order to create a smooth surface for photograph, the film is prepared by subjecting a base film to the coating. Further, the surface layer has a contact angle with respect to water, of 90 degrees, thus possessing an excellent parting performance.

In the present invention, an adhesive force between the film base material and the parting coating layer formed as the surface layer of the film is important. A measuring method of the adhesive force between the film base material and the coating layer will be described below.

FIG. 12 is an illustration of a measuring apparatus.

First, the film 8 is fixed on a flat surface 3 so that the parting coating layer is located at the surface. A cylindrical probe 31 with a diameter of 7 mm is fixed with an adhesive on the surface of the coating layer of the fixed film 8 so that a circular surface of the probe 31 is contacted to the coating layer. The probe 31 may desirably be formed of a material, such as metal, which is less deformed even under application of pressure. Then, a force gage 32 is fixed on the cylindrical probe 31 and at a speed of 400 mm/min, the film 8 is vertically pulled from the flat surface 30. A force exerted on the force gage 32 when the coating layer is separated is measured. The measured force was used as the adhesive force between the coating layer and the film base material.

The back surface (slidable with the thermal head 6) of the film is provided with a sticking prevention layer in order to reduce mechanical friction with the thermal head 6. The sticking prevention layer is required to possess a property close to that of the parting coating described above and therefore specifically, coating with the fluorine-containing resin material or the silicone resin material similarly as in the case of the parting layer.

The film 8 in this embodiment, in order to transfer its surface shape, can be processed so as to have a high-gloss and photograph-like (glossy) surface when the film 8 is a high-gloss smooth film. Further, on the other hand, by using a matte film prepared by sandblast or a film provided with a particular shape, a reverse shape of the surface shape can be transferred onto the sheet P. It is possible to transfer shapes with various feels and textures such as those of matte (silky)-finish paper, Japanese Paper and embossed paper. Further, it is also possible to provide a geometric pattern, so that various feeds and textures such as a lattice pattern. Further, by forming a geometric structure on the order of 1 μm to submicrometers, it is possible to transfer a surface which assumes hologram color.

In this embodiment, the sheet P surface can be partly subjected to the glossing and therefore a plurality of the films as described above are provided, so that various shapes and hologram color can be provided at only necessary positions of the sheet P.

### (Separating Member)

The separating member 11 will be described below in detail.

The separating member 11 performs two functions consisting of a film cooling function and a film separating function based on curvature. The separating member 11 is constituted by metal such as SUS (stainless steel) and a separation curvature thereof is set at a sufficiently small value, so that the separating member 11 is constituted so that the sheet P and the film 8 can be parted with more reliability. Here, the separating member 11 contacts the film 8 at a surface opposite from the contact surface, at which the film 8 is contacted to the sheet P, to change the movement direction of the film 8, so that the sheet P and the film 8 can be separated with reliability. Further, it is desirable that a cooling mechanism (not shown) for suppressing temperature rise of the separating member 11. In this regard, e.g., air cooling or mounting of a cooling fin is effective.

Further, by monitoring a temperature of the separating member 11 by using thermistors provided at a plurality of portions, a fan or a printing operation may be controlled so that the temperature of the separating member 11 is not more than a target cooling temperature T1 (° C.).

The target cooling temperature T1 may desirably be made equal to Tg (glass transition point) of the surface layer resin material, such as a colorant or an overcoating material, on the sheet P. When a deviation between Tg and melting start point is taken into consideration, the target cooling temperature T1 may preferably be set at about Tg+15 degrees, further preferably at Tg or less. Further, some colorant layer is formed of the surface layer materials containing a component such as wax in addition to the resin material and the colorant. In this case, the target cooling temperature T1 may preferably be set at a temperature which is not less than a melting point of the wax. For example, the temperature may preferably be about 30-50° C.

In this embodiment, a tension exerted on the film 8 during winding-up of the film 8 is important. A diameter by the film winding-up shaft 12 and the wound film 8 is increased every winding-up of the used film 8 depending on the thickness of the film 8. For that reason, in order to obtain a stable winding-up tension, it is desirable that the film tension is controlled by the torque of the winding-up motor and the torque of the winding-up motor is controlled in consideration of the increase in diameter by the winding-up shaft 12 and the wound film 8. The film 8 is wound by a length corresponding to the length of the sheet P and after the end of the printing (glossing), the platen roller 5 is spaced from the thermal head 6. The gloss-recorded sheet P is successively nip-conveyed in the order of the sheet feeding roller pair 4 and the sheet discharging roller pair 9 and is finally discharged to the outside of the casing, so that the recording is ended. Incidentally, as the sheet P, rolled paper is also usable.

In this embodiment, a constitution in which the glossing can be performed plural times while reciprocating the sheet P by the sheet feeding roller pair 4 is employed but the present invention is not limited to such a constitution. For example, it is also possible to effect the glossing while rotating a platen drum plural times. Further, it is also possible to employ a constitution in which the platen roller is directly driven and the glossing is effected only one time with respect to one direction.

### [Evaluation Method]

The print used to evaluate the gloss alteration apparatus in this embodiment was made as follows:

First, a solid black image was printed on a sheet of recording paper, which was A3 in size. Then, the print was process with the use of the gloss data of a solid black image, which was 19 cm in width and 35 cm in length.

### (a) Peeling of Coated Layer of Film

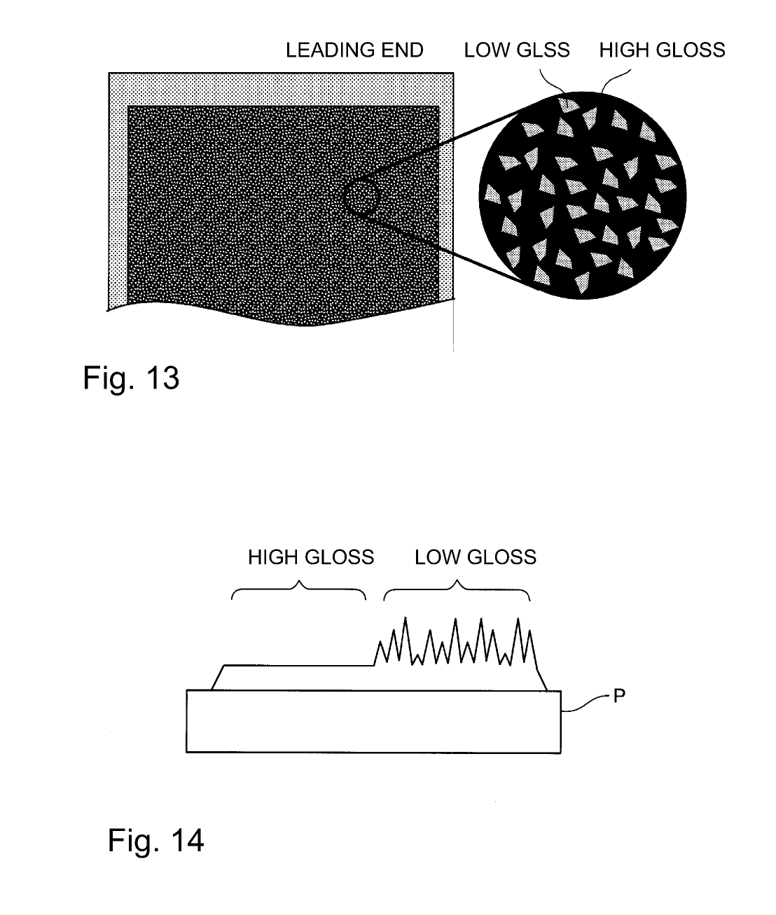

FIG. 13 shows the print, the surface of which is covered with small pieces of the coat layer having peeled away from the film. If the coat layer of the film 8 separated from a given area of the film 8, the separated coated layer adheres to the portion of the sheet P, which corresponds in position to the separated portion of the coated layer. Thus, this portion of the sheet P reduces in gloss. Whether or not the coat layer from the film 8 was on the surface of the sheet P was determined with the use of a microscope, and the resultant print was evaluated based on the following standard.

O: no trace of coat layer from film 8, on surface of sheet P

X: presence of coat layer from film 8, on surface of sheet P

### (b) Gloss Irregularity

FIG. 14 shows a print which became irregular in gloss. If the operation of a gloss alteration apparatus is continued after the position at which the film 8 separates from the sheet P has shifted downstream in terms of the direction the sheet P is discharged, the gloss alteration apparatus outputs prints which are rough across the entirety of its surface, being therefore low in gloss. The prints were evaluation in terms of the amount by which they decreased in gloss, by measuring the prints in 60 degree gloss with the use of Tri-glossmeter (product of BYK-Gardner Co., Ltd.).

In the case of this embodiment, the prints were evaluated based on the image quality in terms of whether or not the gloss-altered portion of a print is as glossy as a photographic image. The evaluation was made based on the following standard:

O: no irregularity in gloss (lowering of gloss) across entirety of print; print was no less than 80% in 60 degree gloss

Δ: some areas of print are no more than 80% in 60 degree gloss

X: film 8 did not separate from sheet P (prints could not be evaluated)

### (c) Unsatisfactory Sheet Discharge During Continuous Gloss Alteration Operation

50 prints having the above described apparatus evaluation image were outputted, and the prints which entered the nip between the pair of sheet conveyance rollers 4 without completely separating from the film 8, and therefore, failed to be properly discharged from the gloss alteration apparatus, were counted. The gloss alteration apparatus was evaluated based on the following standard:

O: all 50 prints were properly discharged

X: one or more prints were improperly discharged, or failed to be discharged

### [Description of Gloss Alteration Mechanism of Gloss Alteration Apparatus in This Embodiment]

In this embodiment, in which the superficial texture of the film 8 is transferred onto the surface of a print (sheet P) which is to be altered in gloss, it is desired, from the standpoint of how accurately the surficial texture of the film 8 is transferred, that the film 8 smoothly separates from the sheet P. In this embodiment, in order to improve the gloss alteration apparatus in terms of the separation of the film 8 (film substrate) from the resinous surface layer (coat) of the print (sheet P), the film 8 used in this embodiment is provided with a surface layer which is low in the amount of surface energy. That the layer coated on the surface of the substrate of the film 8 for the better separation of the film 8 from the print (sheet P coated with resin) is low in the amount of surface energy means that it does not adhere to the substrate as desirably as it is wanted. Thus, as the film 8 bends, the certain portion of the coated layer of the film 8 in this embodiment sometimes separates from the substrate, and transfers onto the surface of the print (sheet P), even if the angle by which the film 8 is bent is very small.

Further, not only is there a strong correlation between the strength of adhesion between the coated parting layer and substrate of the film 8 and the separation of the coated parting layer of the film 8, but also, between the force to which the coated parting layer is subjected and the separation of the coated parting layer of the film 8.

In this embodiment, therefore, in order to efficiently heat a part or parts of the surface of the sheet P (print) by the thermal head 6 through the film 8, the film 8 has to be very thin. If the film 8 is very thin, its substrate is less rigid, being therefore more likely to stretch as it is subjected to tensile force. On the other hand, the coated parting layer with which the film 8 is provided for improving the film 8 in its separation from a print (sheet P) is different in properties from the substrate of the film 8, being therefore different in the amount by which it stretches as the film 8 is subjected to tensile force. Therefore, if the film 8 is bent by a large angle, is subjected to a large amount of tensile force, and/or is put in the like situation, a part or parts of the film 8 extend, sometimes causing thereby the portion or portions of the coated parting layer, which fail to stretch with the substrate of the film 8, to crack across their surfaces. Thus, it seems to be reasonable to think that the relationship among the strength of adhesion between the substrate and coated parting layer of the film 8, the amount of the tension generated in the film 8 as the film 8 is taken up, and radius of curvature of the peripheral surface of the roughly semi-cylindrical portion of the separating member 11, is strongly related to the peeling of the coated parting layer of the film 8 from the substrate of the film 8.

In this embodiment, therefore, the gloss alteration apparatus was improved by paying attention to the strength of the adhesion between the substrate and coated parting layer of the film 8, amount of tension generated in the film 8 as the film 8 is taken up (wound), and radius of curvature of the peripheral surface of the roughly semi-cylindrical portion of the separating member 11. Through the earnest studies of the aforementioned relationship, the inventors of the present invention discovered that the following are the conditions required to realize a gloss alteration apparatus, the coated parting layer of the gloss alteration film of which does not separate from the substrate of the gloss alteration film, and therefore, does not output a print which is unsatisfactory in terms of gloss (lower in gloss than intended), more specifically, a print which is low in gloss because of the adhesion of minute flakes of the parting layer, which results from the separation of the parting layer of the film 8 from the substrate of the film 8, to the print surface: The strength of adhesion between the substrate and coated parting layer of the film 8 is no less than 10 N/cm²; the amount of tensile force to which the film 8 is subjected is no less than 2 gf/cm and no more than 170 gf/cm; and the radius of curvature of the peripheral surface of the semi-cylindrical portion of the separating member 11 is no less than 0.5 mm and no more than 3.0 mm. In a case where the radius of curvature of the peripheral surface of the semi-cylindrical portion of the separating member 11 is no less than 3.0 mm, for example, it is 4.0 mm, the gloss alteration apparatus outputted prints which were wrong in gloss. On the other hand, in a case where the strength of adhesion between the substrate and coated parting layer of the film 8 is no more than 10 N/cm², that is, the strength of adhesion between the substrate and coated parting layer of the film 8 is small, peeling of the coated parting layer occurred. Further, in a case where the amount of tensile force to which the film 8 was subjected was no less than 170 gf/cm and the radius of curvature of the peripheral surface of the semi-cylindrical portion of the separating member 11 is no more than 0.5 mm, the portions of the coated parting layer of the film 8, which could not accommodate the stretching of the film 8, cracked across their surfaces, and the coated parting layer peeled from the substrate, starting from the cracks. In comparison, in a case where the amount of tensile force to which the film 8 was subjected was no less than 2 gf/cm, or the radius of curvature of the separating member 11 was no less than 0.3 mm, the amount of force generated by the separating member 11 in the direction to separates the film 8 from the sheet P was insufficient for the film 8 to be properly separated from the sheet P.

Further, if it is not ensured that the film 8 reliably separates from the sheet P, the film 8 does not always separate from the image (on sheet P) at the normal point; the point at which the film 8 separates from the image sometimes shifts in the sheet discharge direction. If the point of separation shifts in the sheet discharge direction, in other words, if the film 8 separates from the image (on sheet P) in a range in which the separating member 11 is not present, the film 8 curves downward, because the film 8 is relatively low in rigidity. Therefore, the film 8 becomes nonuniform in tension in terms of its lengthwise direction. Thus, a part or parts of the film 8 separates from the sheet P later than the rest of the film 8. Consequently, force is concentrated to the part or parts of the film 8 and corresponding part or parts of the sheet P. Thus, a part or parts of the surface layer of the image on the sheet P, which are formed of wax or the like, are transferred onto the film 8. As a result, the surface of the image on the sheet P become rough, reducing thereby gloss. Therefore, it is reasonable to think that the production of an image with an abnormal gloss pattern, which is attributable to the positional deviation of the point at which the film 8 separates from the sheet P, is strongly related to the force generated by the separating member 11 in the direction to separate the film 8 from the sheet P, that is, the amount of tension generated in the film 8 by the force applied to the film 8 by the take-up roller, and the radius of curvature of the separating member 11.

In this embodiment, therefore, attention was paid to the amount of force applied to pull the film 8 to take up (wind) the film 8, and the radius of curvature of the separating member 11, in order to improve a gloss alteration apparatus. As a result of the earnest studies of these factors and their relationship, the inventors of the present invention discovered that as long as the amount of force by which the film 8 is pulled by the take-up shaft is no less than 15 gf/cm and no more than 170 gf/cm, and the radius of curvature of the separating member 11 is no less than 0.5 mm and no more than 2.0 mm, it was possible to prevent the point of separation between the film 8 and image, from deviating in the sheet discharge direction. In other words, as long as a gloss alteration apparatus is structured so that the above-described conditions are met, it can output a desirable image. On the other hand, if the amount of the force to which the film 8 was subjected when it was pulled by the take-up roller was no more than 15 gf/cm, or the radius of curvature of the separating member 11 was no less than 2.0 mm, the point of separation between the film 8 and image deviated in the sheet discharge direction, and an image which was wrong in gloss was outputted.

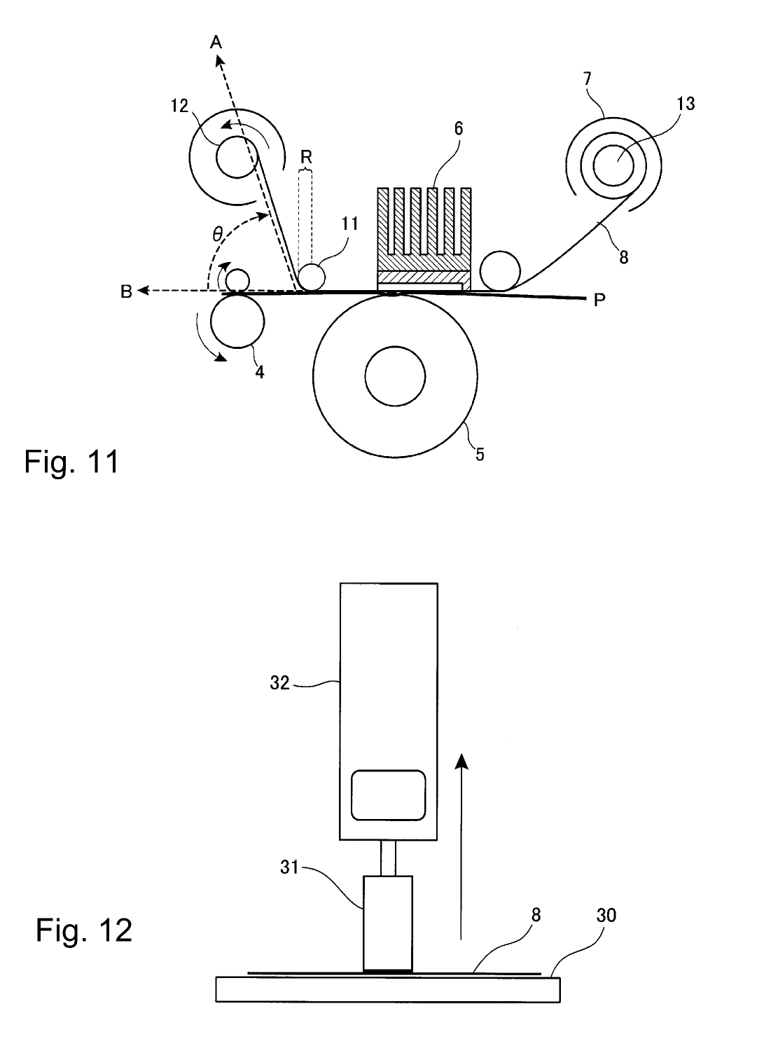

Further, the angle θ of separation between the film 8 and sheet P at the point of separation is no more than 90°, the direction in which the film 8 is pulled to be taken up (wound), and the direction in which the sheet P is conveyed, become the same (for example, leftward in FIG. 11). Therefore, even when the amount of force generated by the separating member 11 to cause the film 8 to separate from the image is sufficient, the film 8 and image sometimes pass by the normal point of separation without separating from each other. If the film 8 and image enters the interface between the pair of sheet conveyance rollers 4 without separating from each other, the film 8 wraps around one of the sheet conveyance rollers 4, preventing thereby the sheet P from being properly discharged.

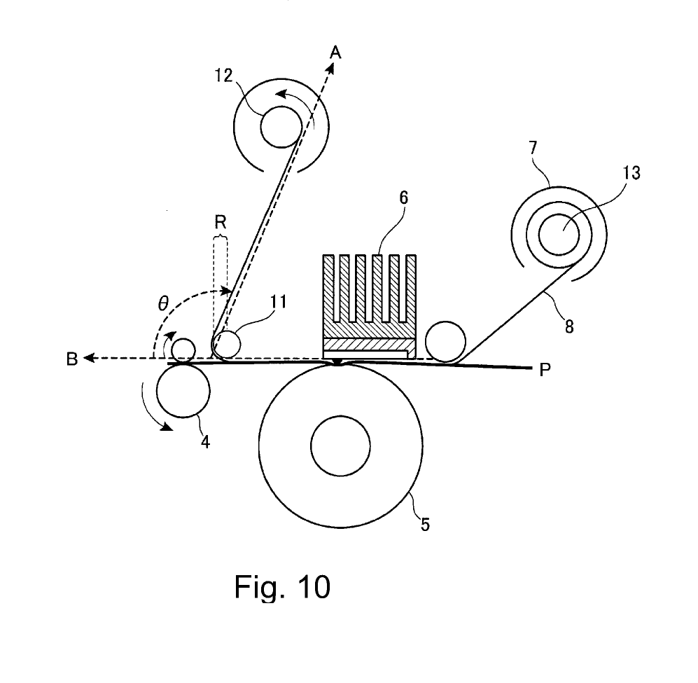

In this embodiment, therefore, in order to make the direction in which the film 8 is pulled to be taken up (wound), opposite to the direction in which the sheet P was conveyed, the gloss alteration apparatus was structured so that the angle of separation between the film 8 and sheet P became no less than 90°. Thus, it was possible to prevent the point of separation between the film 8 and sheet P from deviating in the sheet discharge direction. For example, referring to FIG. 10, the film 8 is pulled rightward in terms of left-right (right-left) direction of the drawing, between the separating member 11 and take-up shaft 12, to be taken up (wound), whereas the sheet P is conveyed leftward. With this setup, it was possible to prevent the problem that a gloss alteration apparatus fails to properly discharge the sheet P because the film 8 enters the interface between the pair of sheet conveyance roller 4 without separating from the sheet P. Therefore, the gloss alteration apparatus properly discharged the sheet P.

### [Results of Evaluation of Gloss Alteration Apparatuses in Preferred Embodiments and Comparative Gloss Alteration Apparatuses]

The results of the evaluation of the gloss alteration apparatuses in the preferred embodiments of the present invention and comparative gloss alteration apparatuses are given in Table 2.

TABLE 2

| | | | | | Evaluation | | |
|---|---|---|---|---|---|---|---|
| | Structure | | | | | Suppression | Suppression |
| | Bonding | Winding | Radius of | Separation | Suppression | Against | Against |
| | Strength | Tension | Curvature | Angle | Against | Sep. Pos. | Sheet |
| | (N/cm²) | (gf/cm) | (mm) | (deg.) | Peeling | Change | Discharge |
| Emb. 11 | 10 | 2 | 3 | 70 | ◯ | Δ | x |
| Emb. 12 | 10 | 170 | 0.5 | 70 | ◯ | ◯ | x |
| Emb. 13 | 15 | 15 | 2 | 70 | ◯ | ◯ | x |
| Emb. 14 | 15 | 120 | 0.5 | 100 | ◯ | ◯ | ◯ |
| Comp. 3 | 1 | 120 | 0.5 | 70 | X | Δ | x |
| Comp. 4 | 10 | 185 | 0.5 | 70 | X | Δ | x |
| Comp. 5 | 10 | 120 | 0.1 | 70 | X | Δ | x |
| Comp. 6 | 15 | 1 | 0.5 | 70 | Non- | x | x |
| | | | | | evaluatable | | |
| Comp. 7 | 15 | 120 | 10 | 70 | Non- | x | x |
| | | | | | evaluatable | | |

### Embodiment 11

In this embodiment, as the film 8, the film 8 having the adhesive force, between the film base material and the coating layer formed at the film surface, of 10 N/cm² was used. Further, a device constitution as shown in FIG. 11 was employed by setting the film winding-up tension at 2 gf/cm, the radius of curvature of the separating member 11 at 3 mm, and a separation portion angle between the film 8 and the sheet P at 70 degrees.

### Embodiment 12

In this embodiment, as the film 8, the film 8 having the adhesive force, between the film base material and the coating layer formed at the film surface, of 10 N/cm² was used. Further, a device constitution as shown in FIG. 11 was employed by setting the film winding-up tension at 170 gf/cm, the radius of curvature of the separating member 11 at 0.5 mm, and the separation portion angle between the film 8 and the sheet P at 70 degrees.

### Embodiment 13

In this embodiment, as the film 8, the film 8 having the adhesive force, between the film base material and the coating layer formed at the film surface, of 15 N/cm² was used. Further, a device constitution as shown in FIG. 11 was employed by setting the film winding-up tension at 15 gf/cm, the radius of curvature of the separating member 11 at 2 mm, and a separation portion angle between the film 8 and the sheet P at 70 degrees.

### Embodiment 14

In this embodiment, as the film 8, the film 8 having the adhesive force, between the film base material and the coating layer formed at the film surface, of 15 N/cm² was used. Further, a device constitution as shown in FIG. 11 was employed by setting the film winding-up tension at 120 gf/cm, the radius of curvature of the separating member 11 at 0.5 mm, and the separation portion angle between the film 8 and the sheet P at 100 degrees.

### Comparative Embodiment 3

In this comparative embodiment, as the film 8, the film 8 having the adhesive force, between the film base material and the coating layer formed at the film surface, of 1 N/cm² was used. Further, a device constitution as shown in FIG. 11 was employed by setting the film winding-up tension at 120 gf/cm, the radius of curvature of the separating member 11 at 0.5 mm, and a separation portion angle between the film 8 and the sheet P at 70 degrees.

### Comparative Embodiment 4

In this comparative embodiment, as the film 8, the film 8 having the adhesive force, between the film base material and the coating layer formed at the film surface, of 10 N/cm² was used. Further, a device constitution as shown in FIG. 11 was employed by setting the film winding-up tension at 185 gf/cm, the radius of curvature of the separating member 11 at 0.5 mm, and the separation portion angle between the film 8 and the sheet P at 70 degrees.

### Comparative Embodiment 5

In this comparative embodiment, as the film 8, the film 8 having the adhesive force, between the film base material and the coating layer formed at the film surface, of 10 N/cm² was used. Further, a device constitution as shown in FIG. 11 was employed by setting the film winding-up tension at 120 gf/cm, the radius of curvature of the separating member 11 at 0.1 mm, and a separation portion angle between the film 8 and the sheet P at 70 degrees.

### Comparative Embodiment 6

In this comparative embodiment, as the film 8, the film 8 having the adhesive force, between the film base material and the coating layer formed at the film surface, of 15 N/cm² was used. Further, a device constitution as shown in FIG. 11 was employed by setting the film winding-up tension at 1 gf/cm, the radius of curvature of the separating member 11 at 0.5 mm, and the separation portion angle between the film 8 and the sheet P at 70 degrees.

### Comparative Embodiment 7

In this comparative embodiment, as the film 8, the film 8 having the adhesive force, between the film base material and the coating layer formed at the film surface, of 15 N/cm² was used. Further, a device constitution as shown in FIG. 11 was employed by setting the film winding-up tension at 120 gf/cm, the radius of curvature of the separating member 11 at 10 mm, and a separation portion angle between the film 8 and the sheet P at 70 degrees.

In each of Embodiments, the film 8 having the adhesive force between the film base material and the coating layer formed at the film surface, of 10 N/cm² is used. On the other hand, in Comparative Embodiment 3, the film 8 having the adhesive force of less than 10 N/cm² is used and therefore the separation of the coating layer from the film base material occurs.

Further, in each of Embodiments, the film winding-up tension is 2 gf/cm or more and 170 gf/cm or less, so that the separation of the coating layer from the film base material is suppressed. On the other hand, in Comparative Embodiment 4, the film winding-up tension is more than 170 gf/cm and therefore the separation of the coating layer occurs. In Comparative Embodiment 6, the film winding-up tension is less than 2 gf/cm and therefore the film 8 and the sheet P are not separated from each other.

Further, in each of Embodiments, the radius of curvature of the separating member 11 is 0.5 mm or more and 3.0 mm or less, so that the separation of the coating layer from the film base material is suppressed. On the other hand, in Comparative Embodiment 5, the radius of curvature of the separating member 11 is less than 0.5 mm and therefore the separation of the coating layer occurs. In Comparative Embodiment 7, the radius of curvature of the separating member 11 is more than 3.0 mm and therefore the film 8 and the sheet P are not separated from each other.

Further, in Embodiments 12, 13 and 14, the film winding-up tension was 15 gf/cm or more and the radius of curvature of the separating member 11 was 2.0 mm or less, so that a separating force between the film 8 and the sheet P was sufficiently exerted on the separating member 11. As a result, it was possible to suppress the improper gloss due to the change in separation position between the film 8 and the sheet P. On the other hand, in Embodiment 11, the film winding-up tension is less than 15 gf/cm and the radius of curvature of the separating member 11 is more than 2.0 mm, so that the separating position of the film 8 from the image is deviated from a normal separating portion toward the sheet discharging direction and the image surface shape is disturbed to lower the glossiness.

Further, in Embodiment 14, the separation portion angle between the film 8 and the sheet P was more than 90 degrees (obtuse angle), i.e., the film 8 was folded back at an acute angle with respect to the conveyance direction of the sheet P. As a result, it was possible to suppress improper sheet discharge resulting from entrance of the film 8 into the sheet feeding roller pair 4 with no separation from the image. On the other hand, in Embodiments 11, 12 and 13, the separation portion angle θ between the film 8 and the sheet P is less than 90 degrees (acute angle). For this reason, when the glossing of the image on 50 sheets was effected, the film 8 entered the sheet feeding roller pair 4 in the state in which the film 8 and the image were not separated from each other to be wound about the sheet feeding roller pair 4, so that the improper sheet discharge occurred in some cases.

### Third Embodiment

Next, Third Embodiment will be described. In this embodiment, by controlling the thermal head, the shape transfer state from the transfer film onto the thermoplastic resin material can be partly changed. The general structure of the glossing device in this embodiment is substantially identical to that (FIG. 1) in First Embodiment. In the following, a difference from First Embodiment will be principally described.

### (Film)

The film 8 is provided slidably on the thermal head 6 and has a surface shape for subjecting the sheet P including the thermoplastic resin material at its surface (at an image forming surface side). Further, the film 8 is constituted by a thin flexible material in order to locally heat the sheet surface. From this viewpoint, the film thickness may desirably be 40 μm or less. From the viewpoint of glossing (gloss treatment), the glossing can be performed until the film thickness of 2 μm but from the viewpoint of film strength, the film thickness may preferably be 4 μm or more. However, in this embodiment, from the viewpoints of ease of temperature control at the film surface and ease of adhesiveness to the recording material, the film 8 may preferably be thinner for controlling a degree of the transfer. Therefore, gloss gradation property had precedence over a mapping property at the glossy surface and the following film formulation was selected. Further, in glossing, in order to obtain a surface property excellent in photograph-like image clarity, it is effective that the film 8 has rigidity to some extent. In the case of materials shown below, the film thickness may preferably be 8 μm or more. Further, with respect to the film material, the material is required to possess a heat resistance property against the thermal head 6. The material, such as polyimide, having the heat resistance property which exceeds 200 degrees. However, although a heating history remains, it is also possible to use a film of a general resin material such as PET (polyethylene terephthalate).

In this embodiment, as a specific transfer film, either of the following film members was used.

Film (3): PET film+parting coating, total thickness of 5.0 μm

Film (4): PET film+one-side blasting, total thickness of 20 μm

In the film (3), a surface layer (surface to be contacted to the sheet P) is subjected to parting coating. This functional layer is a coating layer with low surface energy and the parting coating has been effected in order to improve a parting property between the film 8 and the thermoplastic resin material at the sheet P surface. In the case where the case where the surface shape of the film 8 is transferred, from the viewpoint such that how to accurately transfer the shape of the film 8 onto the sheet P, it is desirable that the film 8 and the sheet P are smoothly parted (separated) from each other. As a composition for this purpose, it is possible to use, e.g., a fluorine-containing resin material, a silicone resin material, and the like. Further, as a forming method, the coating is used in this embodiment but the forming method is not limited thereto. It is important that the film can possess the surface property (surface shape) to be transferred. In this embodiment, in order to create a smooth surface for photograph, the film is prepared by subjecting a base film to the coating. It is also possible to use, e.g., a polypropylene-based film for which the base film alone has the low surface energy. However, the polypropylene-based resin material has a low heat-resistant temperature and therefore specification degradation occurs unless sticking prevention at a back surface, a lowering in amount of overheating, low-speed recording and the like are devised. In this embodiment, from balance of these factors, the film as described above was used. Further, the surface layer has a contact angle with respect to water, of 90 degrees, thus possessing an excellent parting performance. The surface layer may preferably have the contact angle (with respect to water) of 80 degrees or more in order to keep the parting performance. The contact angle, with respect to water, of the surface layer of the film (3) was 75 degrees.

The back surface (slidable with the thermal head 6) of each of the films (3) and (4) is provided with a sticking prevention layer. This layer is provided in order to reduce mechanical friction with the thermal head 6. The sticking prevention layer is required to possess a property close to that of the parting coating described above and therefore specifically, coating with the fluorine-containing resin material or the silicone resin material similarly as in the case of the parting layer.

The film 8 in this embodiment, in order to transfer its surface shape, can be processed so as to have a high-gloss and photograph-like (glossy) surface when the film 8 is a high-gloss smooth film. Further, on the other hand, by using a matte film prepared by sandblast or a film provided with a particular shape, a reverse shape of the surface shape can be transferred onto the sheet P. It is possible to transfer shapes with various feels and textures such as those of matte (silky)-finish paper, Japanese Paper and embossed paper. Further, it is also possible to provide a geometric pattern, so that various feeds and textures such as a lattice pattern. Further, by forming a geometric structure on the order of 1 μm to submicrometers, it is possible to transfer a surface which assumes hologram color.

In this embodiment, the sheet P surface can be partly subjected to the glossing and therefore a plurality of the films as described above are provided, so that various shapes and hologram color can be provided at only necessary positions of the sheet P.

### (Energization System)

An energization system of the thermal head is classified into a system in which the number of pulses is made constant and an energization pulse width is controlled and a system in which a constant pulse width train is prepared and the number at pulses is controlled. The former can design a careful gradation-density characteristic but on the other hand, a halftone control portion is complicated. In the latter, the constant pulse width train is prepared and an input gradation level is only allocated again. Therefore, a load on the halftone control portion is light but in order to realize a careful density characteristic, there is a need to prepare the number of pulses which is considerably larger than the number of actual gradation levels. In this embodiment, the former system was used, i.e., the pulse width was controlled with the constant number of pulses, so that the heating amount provided to the film 8 was controlled.

### (Reproduction of Intermediary Gloss)

This embodiment is characterized in that in the case where the surface state of the sheet P before the treatment is different from the surface state of the film 8, a degree of transfer (transfer degree) of the surface shape of the film 8 onto the toner (thermoplastic resin material) on the sheet P by changing the heating amount. Thus, compared with the case where the surface shape of the film 8 is transferred as it is, the gloss (glossiness) in the state in which the transfer degree is changed is referred to as the intermediary gloss (glossiness) in this embodiment. Therefore, the intermediary gloss includes the case where the entire gloss area is uniformly in an intermediary gloss state and the case where a part of the gloss area is partly in the intermediary gloss state.

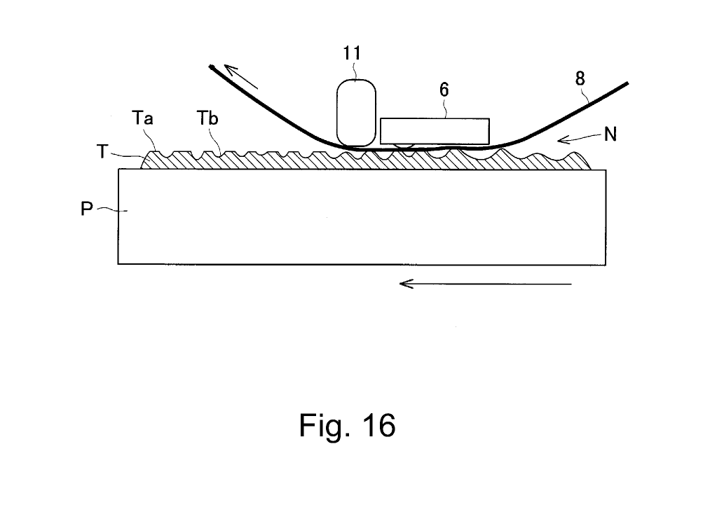

FIG. 16 is a schematic view for illustrating a degree of deformation of the toner T on the sheet P. The surface of the toner T outputted from the copying machine as the electrophotographic image forming apparatus is influenced by the shape of toner particles, thus having roughness to some extent. The film 8 is placed on such a surface and is heated by the thermal head 6, so that melting is started from the toner portion contacted to the film 8 and thus the toner T is stuck on the film surface. The portion stuck on the film surface is then separated from the film 8 to possess a locally smooth surface property and therefore is in a microscopically high gloss state.

In the entire treating area, there are a high gloss area Ta and a low gloss area Tb in mixture as shown in FIG. 16. By adjusting the heating amount, it is possible to change a proportion between the high gloss area Ta and the low gloss area Tb. That is, in the treating area, depending on the heating amount, the glossiness can be changed continuously.

With respect to the control of the heating amount, the above-described pulse width modulation is advantageous. The change in heating amount depending on the pulse width is converted into the temperature at the back surface of the film as it is and further the temperature at the contact portion between the toner and the film 8 is liable to be modulated to increase the proportion of the high gloss area (portion), so that the intermediary surface gloss can be realized.

### [Evaluation Methods]

### (Glossiness (at 60 Degrees and 20 Degrees))

An evaluation of glossiness was performed by measuring 60 degree-glossiness and 20 degree-glossiness of the image. The glossiness was measured by a gloss meter (“TRI-gloss meter”, mfd. by BYK Gardner Inc.). An image sample used for measurement was prepared by outputting, on an A4-sized recording material, patches of 10 colors in total including transparent of the transparent toner in addition to 9 colors consisting of an untreated portion color, CMYK colors, secondary colors and tertiary colors and then by recording an about 1 inch-square gloss data image on the recording material. This sample image was subjected to measurement of the glossiness by the gloss meter.

In this embodiment, in order to evaluate the photograph-like high-gloss surface, evaluation was made according to the following criterion.

o: 80% or more of 60 degree-glossiness

Δ: less than 80% of 60 degree-glossiness

### (Gloss Gradation Property)

The heating amount control of the thermal head 6 is, as described above, effected by variably changing the pulse width with the constant pulse number. The voltage applied to the thermal head 6 is determined so that the glossiness of the treating image is maximum when the pulse width is maximum (100%). The image data (gloss data) in the gloss image is prepared by using saw-tooth-like data which sweeps from start (100%) of the glossing to end (0%) of the glossing and is used in an output test.

The gloss gradation property was evaluated by subjecting the image treated by the above operation to subjective evaluation. As the image on the sheet P, the solid black (Bk) image was used.

⊚: Gloss is continuously changed and is uniformly changed with no non-uniformity in gradation.

o: Gloss is continuously changed with slight non-uniformity in gradation.

Δ: Gradation which is not binary but is continuous is observed but the change in the neighborhood of 100% and 0% is small. As a result, the gloss gradation property is poor.

x: Gloss abruptly appears from an intermediate gradation level and the gradation is binary and discontinuous.

### (Sharpening Property of Gloss Image)

Even when complicated information such as a character is recorded, gloss information is, different from density information, less liable to be discriminated by eyes. For example, on the image surface with uniform density, by recording a pattern such as a character or a figure by using a difference in glossiness, effective gloss representation can be performed. However, as described above, the information is not readily discriminated and thus whether or not an intended effect is achieved is associated with the sharpening property of the gloss image.

In this embodiment, the sharpening property of the gloss image was evaluated in the following manner. A fine difference in glossiness was less recognized by a user and therefore a relatively large pattern was used as the gloss information to be recorded to perform the evaluation. As the image on the sheet P, a solid image of the Bk toner with which the glossiness difference was liable to be discriminated was used. As the gloss information pattern, 36 point-characters of “Arial Black” and “Times” were outputted. The sharpening property of the characters was evaluated by the subjective evaluation according to the following criterion.

o: The characters are readable and the font types can be discriminated.

x: The characters are readable but the font types cannot be discriminated.

### (Gloss Impartment to White Background)

In the glossing, in order to ensure a certain amount of a difference between the high gloss portion and the low gloss portion and in order to obtain togetherness of the high gloss portion image, there is a need that the glossiness is the same irrespective of the image density.

In the evaluation of gloss impartment to the white background, the difference in glossiness among a secondary blue portion (solid portion of magenta toner and cyan toner), a monochromatic portion (solid portion of black (Bk) toner) and a white background portion (formed under white background condition in each of embodiments) on the sheet P was evaluated according to the following criterion.

o: The glossiness difference at 60 degrees is 10% or less.

x: The glossiness difference at 60 degrees exceeds 10%.

In addition, in this embodiment, an average surface roughness of the film surface and the image surface is described. The surface roughness is a value measured in the following manner.

The measurement of the surface roughness was performed by analyzing a configuration profile obtained by optically measuring the surface shape with a surface shape measuring apparatus (“SX 520N”, mfd. by Ryoka Systems Inc.).

Specifically, with respect to a measuring area of about 0.4 mm×0.3 mm, a height at each of measuring points (640×480 pixels) was measured. Further, an interpolating processing function (“Fill” function) of data on the measuring point was enabled to effect the measurement. The measurement was effected after there was 90% or more of effective measuring points. The shape data was analyzed by using an analyzing software (“SX-Viewer (Ver. 3.6.8)”, mfd. by Ryoka Systems Inc.) to obtain the average surface roughness.

More specifically, the shape data was subjected to undulation removal (cut-off: 0.08 mm) by the software to obtain the surface roughness Sa. In the case where there was a defective portion in the measured surface shape area, the surface roughness was measured in the following manner. The defective portion showed a low correlation with an index of an actual surface property (gloss property) and therefore the surface roughness was obtained by selecting an area other than the defecting portion.

Hereinbelow, inherent conditions in Comparative Embodiments and Embodiments will be described. Incidentally, the glossing devices in the respective embodiment basically have the same constitution as that of the above-described glossing device and therefore, for the sake of explanation, constituent portions or members similar to those in the above-described glossing device are represented by the same reference numerals or symbols.

### Embodiment 15

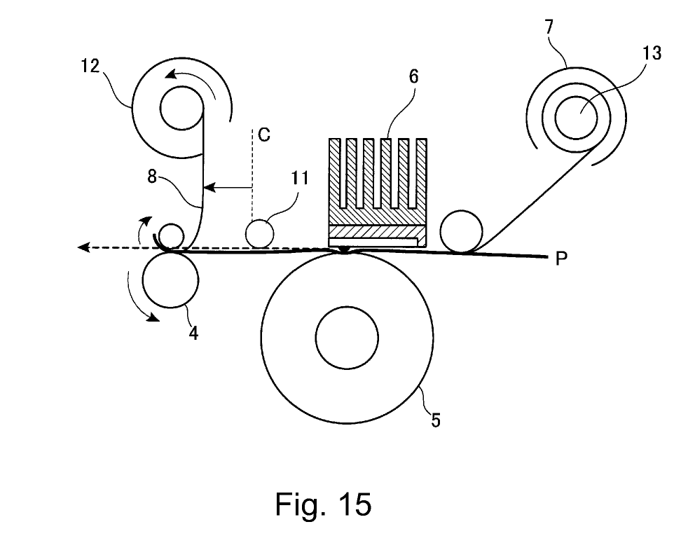

FIG. 15 is a schematic sectional view of the gloss alteration apparatus in the fifteenth embodiment of the present invention. It shows the basic structure of the apparatus.

The image processed (altered in gloss) in this embodiment was an electrophotographic image formed on a sheet of art paper (SA “kanefuji” 157 g/m²): product of Oji Paper Co., Ltd.). The image was formed on the sheet of paper, of the toner which contained coloring agent. The images were formed with a copying machine as an electrophotographic apparatus (image PRESS C1: product of Canon, Co., Ltd.). The surface roughness of the toner image was 0.1 μm. Prior to the gloss alteration, and the 60 degree gloss of the surface of the toner image was 37%.

The film 8 used by the gloss altering apparatus was Film (3) described above. The surface of film 8 (Film (3)), which came into contact with the toner (image) was 0.05 μm in roughness, being therefore capable of making the surface of the toner image flat and glossy. More concretely, the film 8 as gloss alteration film comprised: a substrate film which was formed of PET; a parting layer formed on the substrate film, of silicon resin by coating; and an adhesion prevention layer which was on the opposite side of the substrate layer from the parting layer.

The value of the surface roughness of the toner image was rather large compared to the value of the surface roughness of the film 8. Thus, as the toner image was heated through the film 8, the surface roughness of the toner image became close to that of the film 8. The gloss alteration apparatus was capable of altering the surface of the toner image in gloss in such a manner that the greater was a given point of the toner image in the amount of heat it received, the higher it became in gloss.

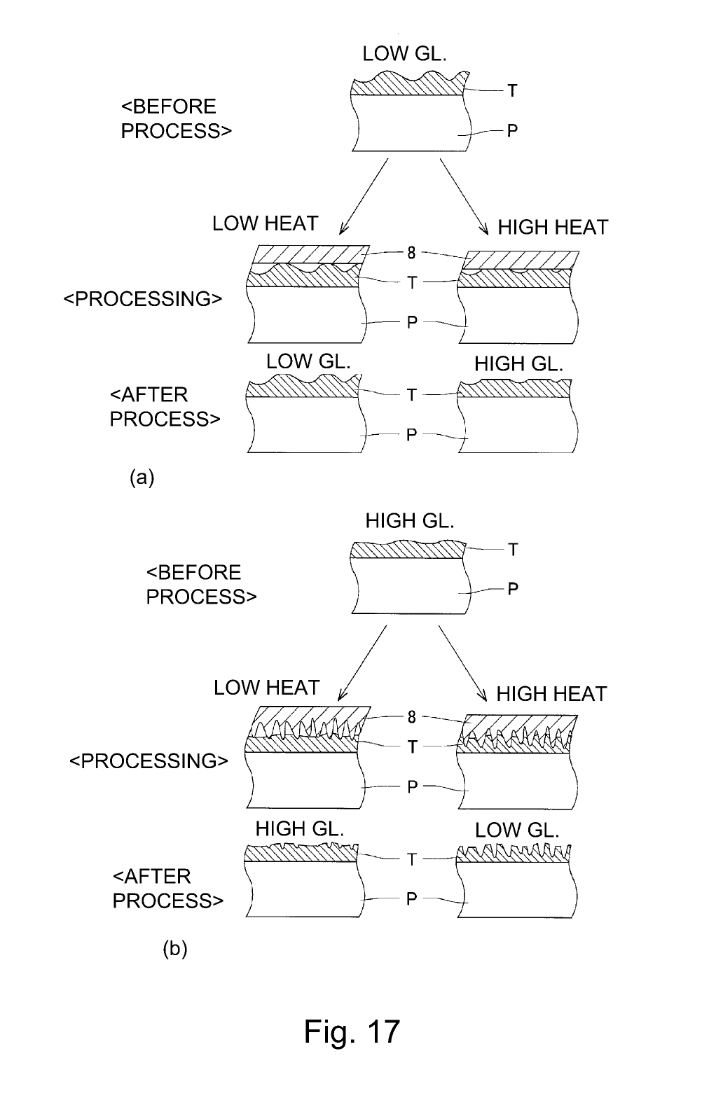

FIG. 17(a) shows the state of the toner image, in cross section, prior to, during, and after the gloss alteration of the toner image. Prior to the gloss alteration, the surface of the toner image had minute peaks and valleys, which were different in intervals and were attributable to: the toner particles which failed to properly melt; halftoning; minute peaks and valleys of the surface of a sheet of recording medium; etc. However, as the toner image surface was heated through the film 8, the toner (toner image) melted by such an extent that was proportional to the applied amount of heat. Thus, the toner image surface gradually became glossier in proportion to the increase in the amount of the applied heat. With the continuation of the heat application, the toner image surface gradually deformed, in particular, across the peak portions of the image. Therefore, the toner image surface gradually became glossier in proportion to the increase in the applied amount of heat. The thermal head 6 can be precisely controlled in the amount by which it applies heat to each point of the toner image. Thus, how glossy the toner image surface is to be made can be controlled by controlling the amount by which heat is applied to the surface of the toner image.

### Embodiment 16

The sixteenth preferred embodiment is an example of the embodiment of the present invention, in which a gloss alteration apparatus was structured to widen the apparatus in terms of the gloss range in which the apparatus can alter a print (image) in gloss. Thus, the fixing apparatus of a copy machine, through which a print is outputted from the copy machine, was changed in the temperature level at which the image was fixed, in order to output images which were greater in surface roughness value.

The image used to test the gloss alteration apparatus in this embodiment was an electrophotographic image formed on a sheet of high quality paper (Npi High Quality 157 g/m²). The image was recorded on recording medium with the toner which contained coloring agent, according to the information about the image to be formed. As for the electrophotographic apparatus, a copying machine (image PRESS C1: product of Canon Co., Ltd.) was used.

The resultant surface roughness of the toner image was 0.31 μm, and the 60 degree gloss of the toner surface prior to the gloss alteration was 12%.

The film 8 of the gloss alteration apparatus was Film (3) described above. The surface of the film 8 (Film (3)), which came in contact with the toner was 0.05 in surface roughness, and could make the surface of the toner image flat and glossy. More concretely, the film 8 had a substrate, a parting layer, and an adhesion prevention layer. The substrate was 4.5 μm in thickness, and was made of PET. The parting layer was made by coating one of the surfaces of the substrate with silicon resin. The adhesion prevention layer was on the opposite side of the substrate from the parting layer.

### Embodiment 17

One of the important issues which comes up when a gloss alteration apparatus is used to output a toner image, the gloss of which is in the medium range, is the sharpness of the glossy image. The gloss alteration apparatus in the seventeenth embodiment of the present invention was an example of a gloss alteration apparatus which was improved in terms of the sharpness of a toner image. In this embodiment, in order to enable a gloss alteration apparatus to output a sharp image when it was set to output an image, the gloss of which was in the medium range, the gloss alteration apparatus was controlled to increase the amount by which heat was applied to the edge portion of the area of the print (image) to be heated. That is, the gloss alteration apparatus was controlled so that the amount by which heat was applied to the border area between an area of the sheet P, which was to be heated, and the adjacent area of the sheet P, which was not to be heated, became greater than the amount by which heat was applied to the area to be heated.

The image used to test the gloss alteration apparatus in this embodiment was an electrophotographic image formed on a sheet of art paper (SA “kanefuji” 157 g/m²): product of Oji Paper Co., Ltd.). The image was record with the use of toner which contained coloring agent, according to the information regarding the image to be formed. The images were formed with a copying machine as an electrophotographic apparatus (image PRESS C1: product of Canon, Co., Ltd.).

The surface roughness of the toner image was 0.24 μm. Prior to the gloss alteration, the 60 degree gloss of the toner image surface was 9%.

The film 8 of the gloss alteration apparatus was Film (3) described above. The surface of the film 8 (Film (3)), which came in contact with the toner was 0.05 μm in surface roughness, and could make the surface of the toner image flat and glossy. More concretely, the film 8 was made up of a substrate, a parting layer, and an adhesion prevention layer. The substrate was 4.5 μm in thickness, and was made of PET. The parting layer was made by coating one of the surfaces of the substrate with silicon resin. The adhesion prevention layer was on the opposite side of the substrate from the parting layer.

In this embodiment, the boundary processing was effected by an unsharp mask. In the case of glossiness treatment, the edge stressing in a low resolution is preferable, as is different from the density image, as a result of the experiments. The change of the glossiness can be observed only at a limited angles relative to the change of the density, and therefore, the shape is not easily discriminated, and wide area treatment is effective for the boundary process. More particularly, the process size is preferably 0.3 mm-2 mm, by which the effect of the stressed image can be provided, and edgeless image does not result. In this embodiment, the unsharp mask is a filter matrix calculated from a Gaussian distribution. The used dispersion σ² is approx. 0.15 mm, and 2σ² is a diameter of the mask (0.3 mm in this embodiment). The above-mentioned, 0.3-2 mm is this diameter. More specifically, the setting is such that the Gaussian distribution is provided with respect to the area of 11 dots (approx. 0.93 mm square) in the writing resolution of 300 dpi.

As for the heat hysteresis process, a conventional method is usable. In such a method, the heating quantity applied to a noting pixel is changed in consideration of the heating quantity data for a several pixels before, and the heating quantity data for a pixel adjacent to (several pixels away from) the noting pixel.

### Embodiment 18

In the eighteenth embodiment, the gloss alteration apparatus was structured to transfer the surface texture of a matte film onto the surface of the toner image to output a toner image which was smoother in the gloss gradation. As for the general structure of the gloss alteration apparatus, a matte film was used as the film 8, and the gloss of the image surface prior to the gloss alternation was set higher.

In this embodiment, what was transferred by heating is the matte texture of the film 8. Thus, the greater the amount by which heat was applied, the less glossy the resultant image was. FIG. 17(b) shows in cross section, the state of the toner image prior to, during, and after the gloss alteration of the toner image.

Unlike in a case where a film, the surface of which was flat and smooth, was used as the film 8, as the amount by which heat was applied was large, and therefore, the more the toner melted, the more closely the toner image surface reflected the surface texture of the matte film (8), and therefore, reduced more in gloss.

The greater the amount by which heat was applied to a toner image, the greater the extent of toner melting, and therefore, the less glossier the surface of the resultant toner image became. In other words, by increasing the toner image surface in gloss, and using a matte film as the film 8, it was possible to alter the toner image surface in gloss in proportion to the amount by which heat was applied to the toner image surface.

In other words, by using a matte film as the film 8, it is possible to suppress the effects of the minutes peaks and valleys (which were low in spatial frequency) which the paper surface has, and/or the peaks and valleys which the surface of a toner image has and are attributable to the insufficiently melted toner particles in the toner image, and therefore, it is possible to output an image which is smooth in gloss gradation.

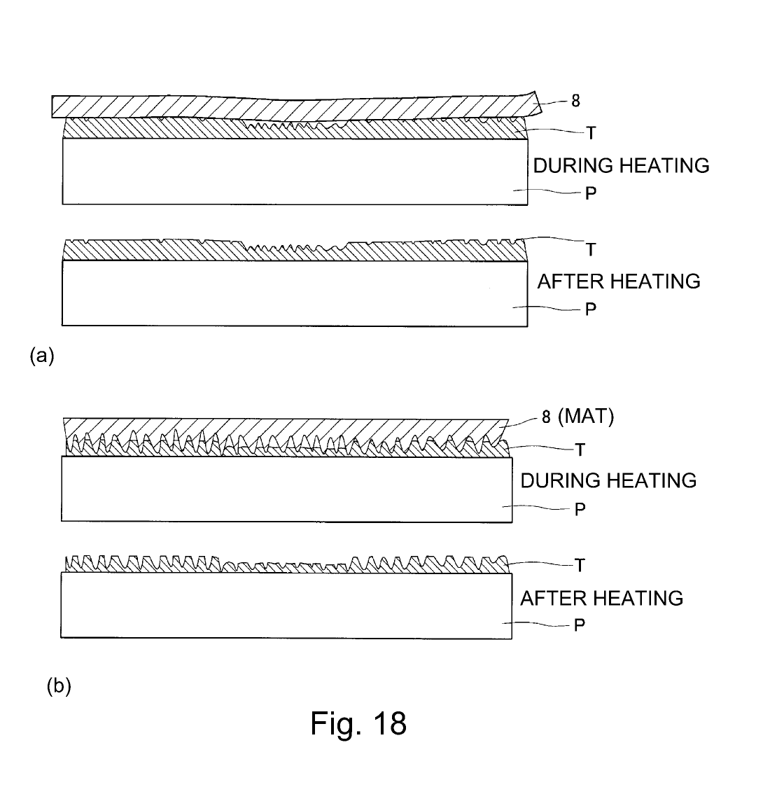

FIG. 18 shows the difference between the usage of a film, the surface of which is flat and smooth, as the film 8, and the usage of a matte film as the film 8.

FIG. 18(a) represents a case in which a high gloss film was used as the film 8. In this case, as the surface texture of the film 8 was transferred onto the toner image surface, the toner image (layer) was affected by the minutes peaks and valleys of the surface of the sheet P, and therefore, it was difficult to provide the toner image with a desired level of gloss, that is, gloss in the intermediary range. In comparison, FIG. 18(b) represents a case in which a matte film, that is, a low gloss film, was used as the film 8 for altering a toner image in gloss. In this case, the film 8, which was matte across its surface, contacted the toner images even if the surface of the sheet P had minutes peaks and valleys. Therefore, the texture of the surface of the film 8 were uniformly transferred onto the surface of the toner image in proportion to the amount by which heat was applied. Further, it was necessary to prepare such data that are reversal to the data for forming a glossy image in the preceding embodiments.

The image used to test the gloss alteration apparatus in this embodiment was an electrophotographic image formed on a sheet of art paper (SA “kanefuji” 157 g/m²): product of Oji Paper Co., Ltd.). The image was recorded on a sheet of art paper with the use of toner which contained coloring agent, according to the information regarding the image to be formed. The electrophotographic apparatus used to form the image was a copying machine (image PRESS C1: product of Canon, Co., Ltd.).

The surface roughness of the toner image was 0.10 μm. The 60 degree gloss of the toner image prior to the gloss alteration was 37%.

The film 8 of the gloss alteration apparatus was Film (4) described above. The surface of the film 8 (Film (4)), which came in contact with the toner image was 0.7 μm in surface roughness. In other words, the matte texture of the film 8 was transferred onto the surface of the toner image. More concretely, the film 8 was made up of a substrate, a parting layer, and an adhesion prevention layer. The substrate was 12.0 μm in thickness, and was made of PET. The parting layer was made by coating one of the surfaces of the substrate with silicon resin. The adhesion prevention layer was on the opposite side of the substrate from the parting layer.

The film 8 in this embodiment was a matte film, which was rather thick. Thus, it was less controllable in surface temperature and greater in the amount of heat it applied to the toner image, compared to the films (8) used in the other embodiments. In this embodiment, not only was the voltage to be applied to the thermal head adjusted, but also, the recording speed was changed to 20 mm/sec.

### Embodiment 19

The nineteenth embodiment is an example of an electrophotographic apparatus capable of using clear toner to transfer the surface texture of the film 8 onto even the blank areas of a sheet of recording medium.

The image used to test the electrophotographic apparatus in this embodiment was an electrophotographic image formed on a sheet of art paper (SA “kanefuji” 157 g/m²): product of Oji Paper Co., Ltd.). The image was recorded on a sheet of art paper with the use of toner which contained coloring agent, according to the information about the image to be formed. The electrophotographic apparatus used to form the image was a copy machine (image PRESS C1: product of Canon, Co., Ltd.).

The surface roughness of the toner image was 0.24 μm. The 60 degree gloss of the toner image prior to the gloss alteration was 9%. The film 8 of the gloss alteration apparatus was Film (3) described above. The surface of the film 8 (Film (3)), which came in contact with the toner image was 0.05 μm in surface roughness. In other words, the flat and smooth surface texture of the film 8 was transferred onto the surface of the toner image. More concretely, the film 8 was made up of a substrate, a parting layer, and an adhesion prevention layer. The substrate was 4.5 μm in thickness, and was made of PET. The parting layer was made by coating one of the surfaces of the substrate with silicon resin. The adhesion prevention layer was on the opposite side of the substrate from the parting layer.

In this embodiment, in order to make it possible to make glossy even the blank areas of a print, clear toner was used in addition to the ordinary color toners to form a test image. That is, the print used to test the gloss alteration apparatus in this embodiment was made by forming an ordinary toner image on a sheet of recording medium, and then, coating the entirety of the image bearing surface of the sheet of recording medium with clear toner.

### [Comparative Electrophotographic Apparatus 8]

The image used to test the first comparative gloss alteration apparatus was an image formed by a thermal transfer method. More specifically, the image was formed on a sheet of art paper (SA “kanefuji” 157 g/m²: product of Oji Paper Co., Ltd.) with the use of a thermal transfer method. The image was recorded on the sheet of paper with the use of wax which contained coloring agent, according to the information of the image to be formed. The recording apparatus used to form the image was a thermal transfer printer (MD-5500: product of Alps Electric Co., Ltd.), which employed a thermal transfer ribbon cartridge (product of Alps Electric Co., Ltd.).

The film 8 of the gloss alteration apparatus was Film (3) described above. The surface of the film 8 (Film (3)), which came in contact with the toner image was 0.05 μm in surface roughness. In other words, the flat and smooth surface texture of the film 8 was transferred onto the surface of the image, that is, a wax layer. More concretely, the film 8 was made up of a substrate, a parting layer, and an adhesion prevention layer. The substrate was 4.5 μm in thickness, and was made of PET. The parting layer was made by coating one of the surfaces of the substrate with silicon resin. The adhesion prevention layer was on the opposite side of the substrate from the parting layer.

### (Results of Evaluation)

Table 3 is the summary of the relationship between the essential structures of each of the gloss altering apparatuses in the fifteenth to nineteenth preferred embodiments of the present invention, and the eighth comparative gloss alteration apparatus, and the evaluation of the images outputted by the apparatuses, in terms of their gloss.

TABLE 3

| | Before Treatment | | Post treating St. | | Effect | | | |
|---|---|---|---|---|---|---|---|---|
| | | Surface | Film | | | | | White |
| | | Roughness | | Surface | | | Gloss | Back- |
| | | Of Image | Surface | Roughness | Glossi- | Gloss | Sharp- | ground |
| | Image/Sheet | (μm) | Property | (μm) | ness | Gradation | ness | Gloss |
| Comp. 8 | F. Transfer | 0.20 | Parting | 0.05 | ◯ | x | x | x |
| | Print/ | | SiPET5 | | | | | |
| | coated | | | | | | | |
| Emb. 15 | Toner image/ | 0.10 | Parting | 0.05 | ◯ | Δ | x | x |
| | coated | | SiPET5 | | | | | |
| Emb. 16 | Toner image/ | 0.31 | Parting | 0.05 | ◯ | ◯ | x | x |
| | coated | | SiPET5 | | | | | |
| Emb. 17 | Toner image/ | 0.24 | Parting | 0.05 | ◯ | ◯ | ◯ | x |
| | coated | | SiPET5 | | | | | |
| Emb. 18 | Toner image/ | 0.10 | No | 0.7 | Δ | ⊚ | x | x |
| | coated | | Parting | | | | | |
| | | | 20 μm | | | | | |
| Emb. 19 | Color toner + | 0.24 | Parting | 0.05 | ◯ | ◯ | ◯ | ◯ |
| | Multi. | | SiPET5 | | | | | |
| | clear toner | | | | | | | |

In the case of the gloss alteration apparatus in the fifteenth embodiment, it was confirmed that the gloss of the resultant image displayed gloss gradation which the images outputted by the eighth comparative apparatus did not display. The images outputted by the eighth comparative apparatus displayed the gloss gradation attributable to the heating method which changed in steps the amount by which heat was to be applied. However, it was difficult to obtain images, the gloss of which was in the mid range, with the use of the comparative apparatus.

In comparison, in the case of the gloss alteration apparatus in the fifteenth embodiment, the manner in which the surface texture of the film 8 was transferred onto the surface of the toner image was closely related to the amount by which heat was applied to a given point of the print (sheet of recording medium). In other words, it was possible to provide desired areas of a print with an intermediary degree of gloss, which could not be provided with the use of the comparative gloss alteration apparatuses. That is, with the employment of a structural arrangement such as the one in the fifteenth embodiment, it is possible to provide a print with an intermediary level of gloss, by controlling (adjusting) the amount by which heat is applied. In other words, with the use of a gloss alteration apparatus such as the one in the fifteenth embodiment, it is possible to continuously output prints which are different in gloss.

In the case of the gloss alteration apparatus in the sixteenth embodiment, prints (images) were altered in gloss while the gloss level for the toner image on the sheet P was set relatively low. The resultant images were richer in terms of gloss gradation compared to those altered in gloss with the use of the other apparatuses.

In the case of the gloss alteration apparatus in the seventeenth embodiment, the border area between a given area of a print covered with toner (toner image) and the adjacent blank area of the print was specifically treated. Thus, the prints, the gloss of which was in the intermediary range, and yet, the letters and the like images on which were substantially sharper, clearer, and more vivid than those obtained by the other apparatuses.

In the case of the gloss alteration apparatus in the eighteenth embodiment, a matte film was used as the film 8, and toner images which were high in surface roughness were altered in gloss. The resultant prints (images) appeared more substantial in quality and superior in gloss gradation than those obtained with the use of other apparatuses. Further, they did not suffer from the defects (effects of peaks and valleys of recording medium surface) associated with a gloss alteration operation in which only a part or parts of a print is altered in gloss. Thus, the images obtained with the use of this gloss alteration apparatus were far superior in image quality in terms of gloss.

In the case of the gloss alteration apparatus in the nineteenth embodiment, the blank areas of the print (sheet P) were coated with clear toner. Therefore, it was possible to adjust a print in gloss regardless of image density. In other words, by structuring a gloss alteration apparatus as structured in the nineteenth embodiment, it is possible to alter a print in gloss at various levels even across the blank areas of the print. That is, the nineteenth embodiment can expand the field in which a gloss alteration apparatus is usable, and makes it possible for a gloss alteration apparatus to be used for providing a print with various levels of gloss which are different in terms of artistic expression. Further, it makes it possible to use a gloss alteration apparatus to prevent an original from being faithfully copied, for example.

There have been proposed various systems for altering a print (sheet of recording medium) in gloss uniformly across the entirety of its surface. These system, however, could not be used to alter only a part or parts of a print in gloss. In particular, a gloss alteration system capable of altering any part or parts of each of multiple prints has not yet been proposed. Further, a gloss alteration system based on the prior art has the problem that it cannot provide a print with a satisfactory level of gloss. It is easy to provide a part or parts of a print with a desired level of gloss by transferring the transparent ink layer coated on a roll of film onto the part or parts of the print. However, a gloss alteration system which provides a print with a desired level and/or pattern of gloss by transferring a gloss providing substance onto a print is different in principle from that by transferring the surface texture of the gloss alteration film onto the surface of the print to be altered in gloss. Therefore, it was problematic in that it could not provide a print with a satisfactory (desired) level of gloss. Moreover, because the system provides a print with a desired level of gloss by transferring a transparent ink layer onto the print, it consumes transparent ink. In other words, the system consumes transparent ink just for providing a print with a desired level of gloss.

As will be evident from the description of the preferred embodiments of the present invention, the present invention make is possible to solve these problems. That is, in the preferred embodiments of the present invention, even a part or parts of a print can be provided with a desired level of gloss with the use of a thermal head. Therefore, any part or parts of each of multiple prints can be provided with a desired level of gloss. Further, a sheet of recording medium coated with thermoplastic resin can be altered in gloss with the use of a thermal head. Therefore, more satisfactory gloss can be provided compared to the gloss which can be provided with the use of a conventional gloss alteration apparatus which relies on a transparent ink layer. Also in the case of the gloss alteration apparatuses in the preferred embodiments, a print is provided with a desired level of gloss by transferring the surface texture of the gloss alteration film onto the thermal plastic layer of a print by softening the thermal plastic layer by heating the thermal plastic layer. Therefore, a print can be provided with a desired level and pattern of gloss without consuming a gloss alteration ribbon having a transparent ink layer.

Incidentally, in this embodiment, the thermal head 6 is provided with the plurality of heat generating elements and can effect intermediary glossing and partial glossing at the surface of the sheet P but the direction is not limited thereto. It is also possible to employ a constitution in which a single heat generating element is provided on the substrate along a sheet width direction (axial direction of the platen roller 5) perpendicular to the movement direction of the sheet P.

Further, in this embodiment, the glossing on the image surface on the sheet outputted by the electrophotographic image forming apparatus is described but the present invention is not limited thereto. The surface treating device of the present invention is also applicable to glossing on a powder coating surface.

While the invention has been described with reference to the structures disclosed herein, it is not confined to the details set forth, and this application is intended to cover such modifications or changes as may come within the purposes of the improvements or the scope of the following claims.

This application claims priority from Japanese Patent Applications Nos. 149183/2010, 149185/2010 and 149186/2010 filed Jun. 30, 2010, Jun. 30, 2010 and Jun. 30, 2010, respectively, which are hereby incorporated by reference.

What is claimed is:

1. A sheet surface treating apparatus comprising:
a heater including a substrate and a heat generating element provided on said substrate;
a transfer film which is movable while contacting said heater;
a pressing member cooperating with said heater to form a nip for feeding a sheet carrying thermoplastic resin material, through said transfer film;
wherein the sheet is fed by the nip together with said transfer film in a state that the thermoplastic resin material is in contact with said transfer film, and is heated by said heater in the nip so that a configuration of a surface of said transfer film is transferred to the thermoplastic resin material, and then is separated from said transfer film;
wherein a downstream end of the said heat generating element with respect to a sheet feeding direction is disposed at a position upstream of an end of the said nip with respect to the sheet feeding direction, and a distance between the downstream end of the said nip and the downstream end of the said heat generating element is not less than 0.4 mm and not more than 2.5 mm.

2. An apparatus according to claim 1, wherein a thickness of the said transfer film is not less than 4 μm and not more than 40 μm.

3. An apparatus according to claim 2, wherein said transfer film includes a film base material and a coating layer, and a bonding strength between said film base material and said coating layer is not less than 10N/cm².

4. An apparatus according to claim 3, further comprising a separating member, contacting a surface of the said transfer film opposite a surface contacting the, for separating the sheet from said transfer film, and a winding-up member for winding said transfer film up, wherein a radius of curvature of the said separating member is not less than 0.5 mm and not more than 3.0 mm, a tension of said transfer film by said winding-up member is not less than 2 gf/cm and not more than 170 gf/cm.

5. An apparatus according to claim 4, wherein a separation angle between said transfer film and the sheet by said separating member is larger than 90 degrees.

6. An apparatus according to claim 1, wherein a plurality of such heat generating elements are arranged in a direction perpendicular to the sheet feeding direction, and said heat generating elements are independently controllable.

7. An apparatus according to claim 6, wherein said heat generating elements are adjustable in heat generation amount, individually.
